(19) United States
(12) Patent Application Publication
(10) Pub. No.: US 2026/0134584 A1
(43) Pub. Date: May 14, 2026

(54) FLOW VALUES ASSOCIATED WITH A DIFFUSION MODEL

(71) Applicant: QUALCOMM Incorporated, San Diego, CA (US)

(72) Inventor: Amirhossein HABIBIAN, Amsterdam (NL)

(21) Appl. No.: 18/947,375

(22) Filed: Nov. 14, 2024

(51) Int. Cl. G06T 11/00; G06T 7/246

(52) U.S. Cl. CPC G06T 11/00; G06T 7/248; G06T 2207/10016

(57) ABSTRACT

A device includes a memory configured to store data corresponding to a diffusion model. The device also includes one or more processors coupled to the memory and configured to perform one or more operations. The device is configured to obtain multiple image frames, and generate multiple latent representation frames based on the multiple image frames. The multiple latent representation frames include latents. The device is also configured to obtain multiple output latent representations generated based on multiple diffusion sampling operations performed on the multiple latent representation frames. The multiple diffusion sampling operations are performed based on the diffusion model. The device is configured to, for a pair of latent representation frames of the multiple latent representation frames, determine flow values based on the multiple diffusion sampling operations performed the pair of latent representation frames. The device is configured to perform, based on the flow values, a video generation operation.

### I. FIELD

The present disclosure is generally related to flow values associated with a diffusion model.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Conventional video processing often employs motion compensation techniques to align video frames to remove crude object movements, such as removing linear motion (or camera motions), to simplify the video for additional video processing. Conventional motion compensation techniques determine a motion estimate, such as an optical flow, that indicates how pixels move (between frames) in the video. To determine the motion estimate, a motion compensation technique may extract an optical flow from pixels, where the optical flow indicates motion of the pixels across multiple frames. Based on the motion estimate, pixels of different frames can be spatially aligned—e.g., pixels of neighboring frames can be aligned with pixels of a frame designated as a reference frame. After the pixel alignment, the additional video processing may be performed and can include video enhancement processing, such as denoising or super-resolution, or video compression processing using a traditional or neural codec, as illustrative, non-limiting examples. While motion compensation techniques are used for conventional video processing, motion compensation techniques have yet to be implemented for video generation, such as video generation performed using a latent diffusion model (e.g., a latent video diffusion model), or applied to a latent space rather than a pixel space. Accordingly, a variety of challenges exist to determine how motion compensation can be implemented for video generation (or to a latent space) and how such an implementation can be improved and optimized for increased efficiency and reduced cost (e.g., computational overhead and latency).

### III. SUMMARY

According to one implementation of the present disclosure, a device includes a memory configured to store data corresponding to a diffusion model. The device also includes one or more processors coupled to the memory and configured to obtain multiple image frames. The one or more processors are also configured to generate multiple latent representation frames based on the multiple image frames. The multiple latent representation frames include latents. The one or more processors are configured to obtain multiple output latent representations generated based on multiple diffusion sampling operations performed on the multiple latent representation frames. The multiple diffusion sampling operations performed based on the diffusion model. The one or more processors are configured to, for a pair of latent representation frames of the multiple latent representation frames, determine flow values based on the multiple diffusion sampling operations performed the pair of latent representation frames. The one or more processors is also configured to perform, based on the flow values, a video generation operation.

According to another implementation of the present disclosure, a method includes obtaining multiple image frames. The method also includes generating multiple latent representation frames based on the multiple image frames. The multiple latent representation frames include latents. The method also includes obtaining multiple output latent representations generated based on multiple diffusion sampling operations performed on the multiple latent representation frames, the multiple diffusion sampling operations performed based on a diffusion model. The method also includes, for a pair of latent representation frames of the multiple latent representation frames, determining flow values based on the multiple diffusion sampling operations performed the pair of latent representation frames. The method also includes performing, based on the flow values, a video generation operation.

According to another implementation of the present disclosure, a non-transitory computer-readable medium storing instructions that are executable by one or more processors to cause the one or more processors to obtain multiple image frames. The instructions further cause the one or more processors to generate multiple latent representation frames based on the multiple image frames. The multiple latent representation frames include latents. The instructions further cause the one or more processors to obtain multiple output latent representations generated based on multiple diffusion sampling operations performed on the multiple latent representation frames, the multiple diffusion sampling operations performed based on a diffusion model. The instructions further cause the one or more processors to for a pair of latent representation frames of the multiple latent representation frames, determine flow values based on the multiple diffusion sampling operations performed the pair of latent representation frames. The instructions further cause the one or more processors to perform, based on the flow values, a video generation operation.

According to another implementation of the present disclosure, an apparatus includes means for obtaining multiple image frames. The apparatus further includes means for generating multiple latent representation frames based on the multiple image frames, the multiple latent representation frames include latents. The apparatus further includes means for obtaining multiple output latent representations generated based on multiple diffusion sampling operations performed on the multiple latent representation frames, the multiple diffusion sampling operations performed based on a diffusion model. The apparatus further includes means for determining, for a pair of latent representation frames of the multiple latent representation frames, flow values based on the multiple diffusion sampling operations performed the pair of latent representation frames. The apparatus further includes means for performing a video generation operation based on the flow values.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system operable to generate flow values associated with a diffusion model, in accordance with some examples of the present disclosure.

FIG. 2 is a diagram of an example of the diffusion model of the system of FIG. 1, in accordance with some examples of the present disclosure.

FIG. 3 is a diagram of an illustrative aspect of operations of a sampling step associated with the system of FIG. 1, in accordance with some examples of the present disclosure.

FIG. 4 is a diagram of an illustrative aspect of operations associated with the system of FIG. 1, in accordance with some examples of the present disclosure.

FIG. 5 is a diagram of an illustrative aspect of operations associated with the system of FIG. 1, in accordance with some examples of the present disclosure.

FIG. 6 is a block diagram of a particular illustrative aspect of a system that is operable to generate flow values associated with a diffusion model, in accordance with some examples of the present disclosure.

FIG. 7 is a block diagram of a particular illustrative aspect of a video generator that is operable to generate flow values associated with a diffusion model, in accordance with some examples of the present disclosure.

FIG. 8 is a diagram of an example of an integrated circuit operable to generate flow values associated with a diffusion model, in accordance with some examples of the present disclosure.

FIG. 9 is a diagram of a mobile device operable to generate flow values associated with a diffusion model, in accordance with some examples of the present disclosure.

FIG. 10 is a diagram of a wearable electronic device operable to generate flow values associated with a diffusion model, in accordance with some examples of the present disclosure.

FIG. 11 is a diagram of a voice-controlled speaker system operable to generate flow values associated with a diffusion model, in accordance with some examples of the present disclosure.

FIG. 12 is a diagram of a camera device operable to generate flow values associated with a diffusion model, in accordance with some examples of the present disclosure.

FIG. 13 is a diagram of a headset, such as a virtual reality, mixed reality, or augmented reality headset, operable to generate flow values associated with a diffusion model, in accordance with some examples of the present disclosure.

FIG. 14 is a diagram of a first example of a vehicle operable to generate flow values associated with a diffusion model, in accordance with some examples of the present disclosure.

FIG. 15 is a diagram of a mixed reality or augmented reality glasses device operable to generate flow values associated with a diffusion model, in accordance with some examples of the present disclosure.

FIG. 16 is a diagram of a second example of a vehicle operable to generate flow values associated with a diffusion model, in accordance with some examples of the present disclosure.

FIG. 17 is a diagram of a particular implementation of a method of generation of flow values associated with a diffusion model, in accordance with some examples of the present disclosure.

FIG. 18 is a diagram of another particular implementation of a method of generation of flow values associated with a diffusion model, in accordance with some examples of the present disclosure.

FIG. 19 is a block diagram of a particular illustrative example of a device operable to generate flow values associated with a diffusion model, in accordance with some examples of the present disclosure.

### V. DETAILED DESCRIPTION

The present disclosure provides systems, apparatus, methods, and computer-readable media for generation of flow values associated with a diffusion model for media content systems. Aspects disclosed herein enable generation of flow values associated with a diffusion model. The flow values (also referred to as latent flows) are associated with motion and may be used to implement motion compensation (a warping operation or an aligning operation) for video generation (or to a latent space). To generate the flow values, multiple diffusion sampling operations using a diffusion model are performed on a pair of latent representation frames. The par of latent representation frames may be generated based on multiple image frames and may include latents. In some embodiments, for each latent representation frame of the pair of latent representation frames, activations are obtained for a least at least one diffusion sampling step of the multiple diffusion sampling steps performed on the latent representation frame. For example, the flow values can be determined for the pair of latent representation frames based on the activations for the pair of latent representations. The flow values (e.g., the latent flows) may be associated with motion that can be used by a video generator to generate video content. In some examples, a video generation operation, such as a warping operation or an aligning operation, is performed based on the flow values. The flow values may be generated based on the diffusion model, such as flow values generated using the activations, and therefore provide little or no additional cost in terms of hardware, computational power consumption, processing delay, or latency, to determine the flow values. The flow values (e.g., latent flows) are fast to compute and may be used to improve video generation, such as by performing, based on the flow values, warping or aligning in the latent space.

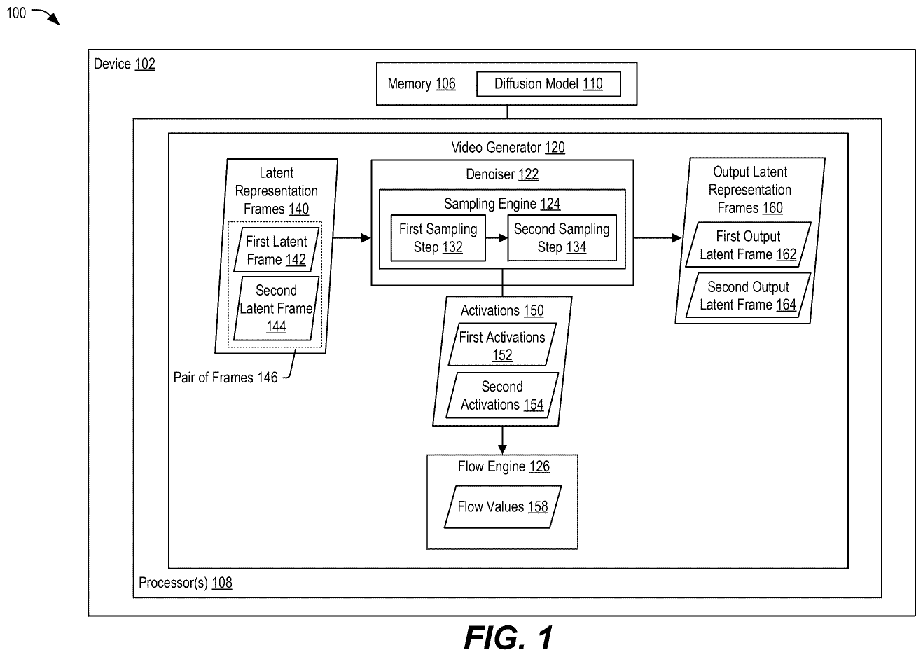

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a processor 108 including one or more processors (“processor(s)” 108 of FIG. 1), which indicates that in some implementations the device 102 includes a single processor 108 and in other implementations the device 102 includes multiple processors 108. For ease of reference herein, such features are generally introduced as “one or more” features and are subsequently referred to in the singular or optional plural (as indicated by “(s)”) unless aspects related to multiple of the features are being described.

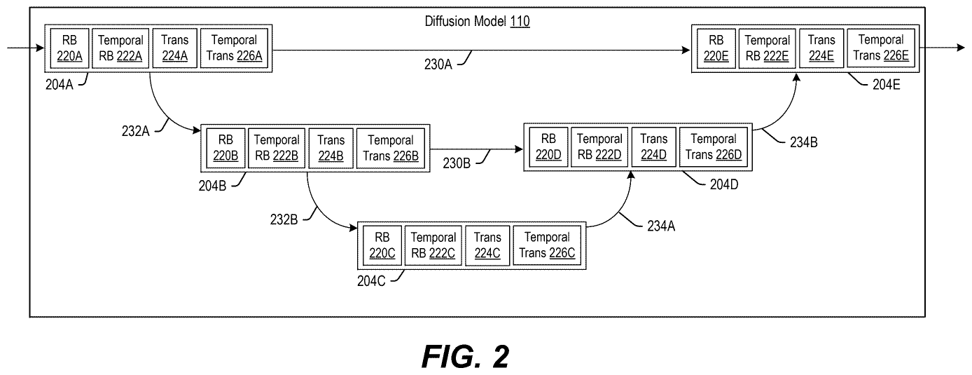

In some drawings, multiple instances of a particular type of feature are used. Although these features are physically and/or logically distinct, the same reference number is used for each, and the different instances are distinguished by addition of a letter to the reference number. When the features as a group or a type are referred to herein—e.g., when no particular one of the features is being referenced, the reference number is used without a distinguishing letter. However, when one particular feature of multiple features of the same type is referred to herein, the reference number is used with the distinguishing letter. For example, referring to FIG. 2, multiple blocks are illustrated and associated with reference numbers 204A, 204B, 204C, 204D, and 204E. When referring to a particular one of these blocks, such as a block 204A, the distinguishing letter “A” is used. However, when referring to any arbitrary one of these blocks or to these blocks as a group, the reference number 204 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

FIG. 1 shows a block diagram of a particular illustrative aspect of a system operable to generate flow values associated with a diffusion model, in accordance with some examples of the present disclosure. The system 100 includes a device 102 that is configured to or is operable to generate flow values associated with a diffusion model.

The device 102 includes a memory 106 and one or more processors 108 (collectively referred to herein as a “processor 108”). The memory 106 may include one or more memories, such as a single memory or multiple different memories (of the same type or of different types). The memory 106 is configured to store a diffusion model 110.

The diffusion model 110 may include a generative model, such as a latent diffusion model (LDM), which is trained in a latent space. The diffusion model 110 may be configured to perform image synthesis with a relatively low computational demand as compared to image synthesis performed in a pixel space. Referring to FIG. 2, FIG. 2 is a diagram of an example of the diffusion model 110 of the system of FIG. 1, in accordance with some examples of the present disclosure. The diffusion model 110 may have a U-Net architecture or another architecture. The U-Net architecture is a type of convolution neural network (CNN). The diffusion model 110 can may include multiple blocks 204. For example, the multiple blocks 204 may include a first block 204A, a second block 204B, a third block 204C, a fourth block 204D, and a fifth block 204E. Although the diffusion model 110 is described as including five blocks, in other examples, the diffusion model 110 can include fewer or more than five blocks. The diffusion model 110 may be arranged in multiple layers, such as a first layer that includes the first block 204A and the fifth block 204E, a second layer that includes the second block 204B and the fourth block 204D, and a third layer that includes the third block 204C.

The U-Net architecture may also be configured to concatenate feature maps from a downsampling path with feature maps from an upsampling path. To illustrate, feature maps output from the first block 204A are downsampled via a first downsample path 232A and provided to the second block 204B, and feature maps output from the second block 204B are downsampled via a second downsample path 232B and provided to the third block 204C. The first block 204A, the first downsample path 232A, the second block 204B, and the second downsample path 232B may correspond to an encoder end (e.g., an encoder portion) of the diffusion model 110. The third block 204C (e.g., the third layer) may be associated with a bottleneck (e.g., a bottleneck portion) of the diffusion model 110. Feature maps output from the third block 204C are upsampled via a first upsample path 234A and provided to the fourth block 204D, and feature maps output from the fourth block 204D are upsampled via a second upsample path 234B and provided to the fifth block 204E. The first upsample path 234A, the fourth block 204D, the second upsample path 234B, and the fifth block 204E may correspond to a decoder end (e.g., a decoder portion) of the diffusion model 110. Additionally, the feature maps output by the first block 204A are provided via a first connecting path 230A to the fifth block 204E and concatenated with the feature maps that are received by the fifth block 204E from the fourth block 204D. The feature maps output by the second block 204B are provided via a second connecting path 230B to the fourth block 204D and concatenated with the feature maps that are received by the fourth block 204D from the third block 204C.

Each block of the multiple blocks 204 includes one or more spatial modules and one or more temporal modules. In some examples, the one or more spatial modules may include a residual block (resblock) module 220 (also referred to as a resblock layer), a transformer module 224 (also referred to as a transfer layer), or a combination thereof. Additionally, or alternatively, the one or more temporal modules may include a temporal resblock module 222 (also referred to as a temporal resblock layer), a temporal transformer module 226 (also referred to as a temporal transfer layer), or a combination thereof. Each block of the multiple blocks 204 may have the same number of spatial modules, the same number of temporal modules, or a combination thereof. In other examples, a first block of the multiple blocks 204 includes a different number of spatial modules, a different number of temporal modules, or both, as compared to a second block of the multiple blocks 204.

In the example depicted in FIG. 2, the first block 204A includes a resblock module 220A, a temporal resblock module 222A, a transformer module 224A, and a temporal transformer module 226A. The second block 204B includes a resblock module 220B, a temporal resblock module 222B, a transformer module 224B, and a temporal transformer module 226B. The third block 204C includes a resblock module 220C, a temporal resblock module 222C, a transformer module 224C, and a temporal transformer module 226C. The fourth block 204D includes a resblock module 220D, a temporal resblock module 222D, a transformer module 224D, and a temporal transformer module 226D. The fifth block 204E includes a resblock module 220E, a temporal resblock module 222E, a transformer module 224E, and a temporal transformer module 226E.

In some embodiments, the resblock module 220, the temporal resblock module 222, or a combination thereof, is configured to perform an upsampling operation (that increases a resolution), a downsampling operation (that lowers a resolution), another operation, or a combination thereof. Additionally, or alternatively, the transformer module 224, the temporal transformer module 226, or a combination thereof, is configured to generate activations. For example, a transformer, such as the transformer module 224 or the temporal transformer module 226, includes an activation function that operates on an input of the transformer to generate activation feature data (or an activation map) that is referred to as activations. The activations (e.g., an activation map) is a rich representation that may indicate or represent image structure information, such as motion associated with an input of the transformer. Within the diffusion model 110, activations associated with a low-resolution block (e.g., the third block 204C) can indicate or represent coarse motion data that is associated with object-level motions (e.g., semantics correspondences), and activations associated with a high-resolution block (e.g., the first block 204A or the fifth block 204E) can indicate or represent fine motion data that is associated with pixel level-type motions (e.g., pixel-level correspondences).

Referring back to FIG. 1, in some examples, the memory 106 further includes or stores instructions that, when executed by the processor 108, cause the processor 108 to perform one or more operations as described herein. In some examples, the memory 106 stores other data, such as media data (e.g., video content) generated by the processor 108.

The processor 108 includes a video generator 120. The video generator 120 includes a denoiser 122 having a sampling engine 124, and includes a flow engine 126. Each of the video generator 120, the denoiser 122, the sampling engine 124, the flow engine 126, or portions thereof, may be implemented by the processor 108 executing instructions (e.g., software), dedicated hardware (e.g., circuitry), or a combination thereof. Although the flow engine 126 is described as being separate from the denoiser 122, in other implementations, the flow engine 126 may be included in the denoiser 122.

The video generator 120 is configured to perform one or more video generation operations associated with generation of video content. For example, the one or more video generation operations may include or correspond to a denoising operation, text-based video content generation, text-based video content editing, video enhancement (e.g., super-resolution, colorization, etc.), video compression, or data augmentation for model training and evaluation.

The denoiser 122 is configured to perform one or more denoising operations, such as one or more diffusion denoising functions, on noise data (e.g., a noise vector) and generate denoised data. For example, the denoiser 122 is configured to use the diffusion model 110 in conjunction with the sampling engine 124 to perform the one or more denoising operations.

The sampling engine 124 is configured to perform multiple steps, such as a series of steps, where each step is configured to implement an instance of the diffusion model 110. For example, the multiple steps of the sampling engine 124 may include a first sampling step 132 and a second sampling step 134.

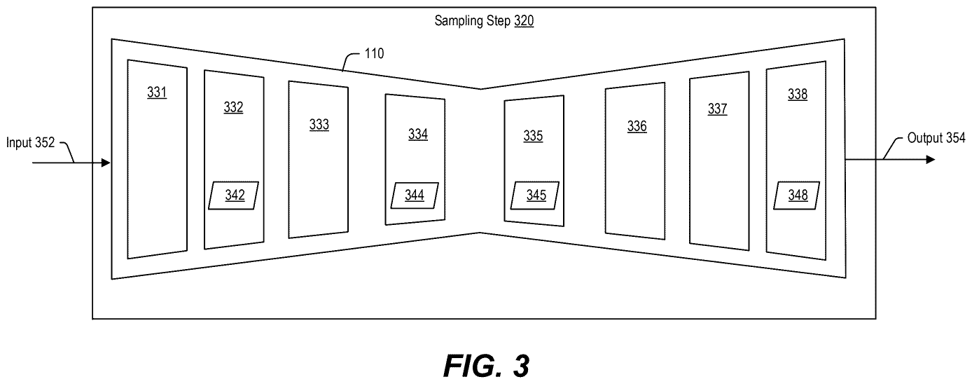

At least one step of the multiple steps may be configured to generate activations. For example, referring to FIG. 3, FIG. 3 is a diagram of an illustrative aspect of operations of a sampling step 320 associated with the system 100 of FIG. 1, in accordance with some examples of the present disclosure. The sampling step 320 may include or correspond to the first sampling step 132 or the second sampling step 134. In some examples, the sampling step 320 is included in the sampling engine 124 and is configured to implement an instance of the diffusion model 110. The sampling step 320 is configured to receive and input 352 (e.g., input latent data) and to perform one or more operations using the diffusion model 110 to generate an output 354 (e.g., output latent data).

As shown in FIG. 3, the diffusion model 110 includes blocks 331-338, such as a first block 331, a second block 332, a third block 333, a fourth block 334, a fifth block 335, a sixth block 336, a seventh block 337, and an eighth block 338. The blocks 331-338 may include or correspond to the blocks 204 of the example of the diffusion model 110 of FIG. 2. One or more of the blocks 331-338 may be configured to generate activations. For example, one or more of the blocks 331-338 may include a respective activation function that generates activations. The activations may be generated or stored in a memory, such as the memory 106 or in a cache memory of the processor 108. In the illustrative example depicted in FIG. 3, the second block 332 may generate activations 342 associated with a first resolution, the fourth block 334 may generate activations 344 associated with a second resolution, the fifth block 335 may generate activations 345 associated with a third resolution, and the eighth block 338 may generate activations 348 associated with a fourth resolution. In some examples, the second resolution and the third resolution are the same resolution and are a lower resolution than each of the first resolution and the fourth resolution. Additionally, or alternatively, the fourth resolution may be a higher resolution than the second resolution. Although four blocks are described as generating activations, in other embodiments, more than four blocks or fewer than four blocks may generate activations.

Referring back to FIG. 1, the flow engine 126 is configured to extract activations 150 from the sampling engine 124 (or otherwise obtain activations 150 that have been generated at the sampling engine 124) and to generate flow values 158 based on the activations 150. The flow values 158 may indicate a flow map that represents a flow of a pair of latent representation frames 146 received by denoiser 122. In some examples, the flow map indicates a flow associated with of an object, a surface, an edge, a pixel, or a combination thereof. The flow values 158 may be used by the video generator 120 to perform motion compensation associated with video generation.

The processor 108 may be configured to use activation maps (e.g., activations) generated by the diffusion model to extract frame correspondences in latent space. For example, the diffusion model 110 used by the denoiser 122 may include or generate information about image structure in a frame. To illustrate, the information may include the intermediate activation maps (e.g., activations) generated using the diffusion model 110.

The processor 108 (e.g., the flow engine 126) may, for each denoising step t∈[T, 0], extract an activation

$${a}_{1 : N}^{t}$$

for all N frames from a denoising UNet f (e.g., the diffusion model 110), where each t corresponds to a sampling step of the sampling engine 124, T is a predetermined number of sampling steps, and the N frames include the latent representation frames. In some implementations, the activations

$${a}_{1 : N}^{t}$$

are extracted from a last (highest transformer module or highest block) of a decoder portion of the diffusion model 110. In other implementations, additionally, or alternatively, the activations

$${a}_{1 : N}^{t}$$

may be extracted from another transformer or block of the diffusion model 110. Each of the activations

$${a}_{1 : N}^{t}$$

may include a set of values that includes a height h and a width w. Additionally, each of the activations

$${a}_{1 : N}^{t}$$

may be associated with a number of tokens K, where K=h×w tokens.

The processor 108 may select a pair of frames of the N frames. The pair of frames, such as the pair of latent representation frames 146, may include a frame i and a frame j. The frames i and j may be adjacent frames in the sequence of the N frames, or may be spaced apart. When the processor 108 selects pairs of frames that are adjacent frames of the N frames, the processor 108 may select N−1 pairs of frames and may determine motion (e.g., flow values or a motion frame) for each of the N−1 pairs of frames. To illustrate, for each pair of frames, the processor 108 computes a distance σ_{i,j}, such as a dot product or a cosine similarity, across all the K=h×w tokens:

$${σ}_{i , j}^{t} = < {a}_{i}^{t} , {a}_{j}^{t} > .$$

Accordingly, each distance

$${σ}_{i , j}^{t}$$

may be represented as a K×K matrix having a first dimension (e.g., height) that corresponds to token index values of the frame i, a second dimension (e.g., width) that corresponds to token index values of the frame j.

The processor 108 may average the distances across the steps to determine an average

$${σ}_{i , j} = \frac{1}{T} {Σ}_{t} {σ}_{i , j}^{t} .$$

In some implementations, the average may be a weighted average in which respective weight values are applied to each of the distances

$${σ}_{i , j}^{t} .$$

The processor 108 may, for each token index value of the frame i—e.g., for each row of the average σ_{i,j}—identify a smallest value of the frame j—e.g., an index value that corresponds to the column of the average σ_{i,j} having the smallest value. In some implementations, to determine the corresponding index values for the frame i and the frame j, the processor 108 performs an argmin (σ_{i,j}) operation. Based on the corresponding index values for the frame i and the frame j, indicating the best matches of tokens in frame i to tokens in frame j, the processor 108 can determine an offset value between the index values, which may be representative of motion and referred to as latent flow fields.

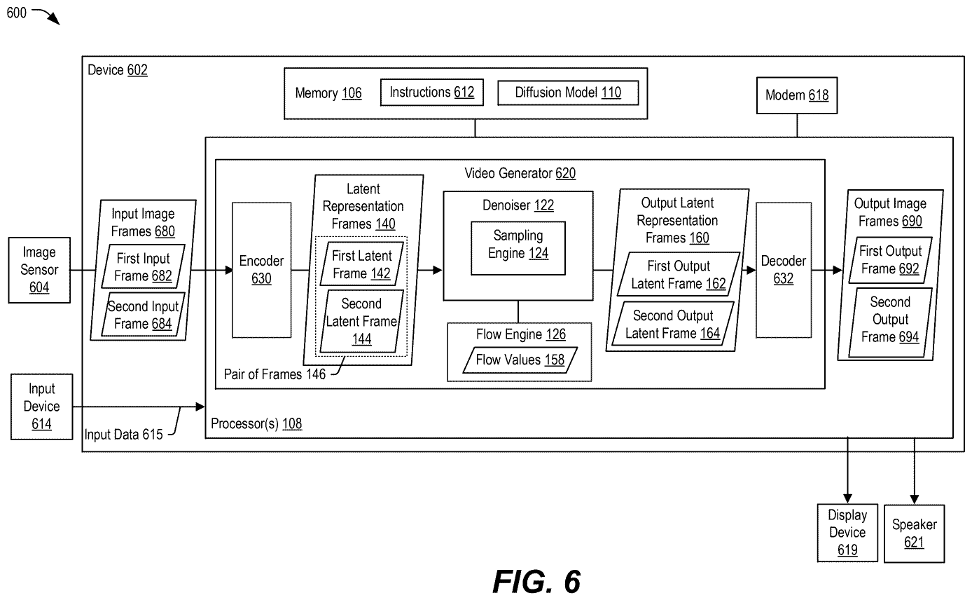

During operation of the system 100, the processor 108 (e.g., the denoiser 122) obtains latent representation frames 140 associated with multiple image frames. The multiple image frames can include a sequence of image frames of video content. In some examples, the denoiser 122 receives the latent representation frames 140 from an encoder, as described further herein at least with reference to FIG. 6. For example, the processor 108 (e.g., the video generator 120) may also include an encoder, such as a variational autoencoder (VAE). The encoder may be configured to receive the input image frames (e.g., a first input frame and a second input frame) and generate the latent representation frames 140 (that include latents) based on the input image frames. For example, the encoder may include a neural network configured to extract latents (e.g., low dimensional representations). In some such examples, the encoder performs one or more operations to compress the input image frames into the latent space. To illustrate, the encoder can receive the first input frame and perform the one or more operations to generate a first latent frame 142. Additionally, or alternatively, the encoder can receive the second input frame and perform the one or more operations to generate a second latent frame 144. In some implementations, the encoder is configured to receive the multiple image frames and, for each image frame of the multiple image frames, encode the image frame to generate a latent representation frame of the latent representation frames 140.

The latent representation frames 140 includes a first latent frame 142 and a second latent frame 144. In some embodiments, the first latent frame 142 and the second latent frame 144 constitute a pair of latent representation frames 146. Each latent representation frame of the latent representation frames 140 include latents that are associated with an array of tokens.

The processor 108 (e.g., the sampling engine 124) performs multiple diffusion sampling steps on the latent representation frames 140 to generate output latent representation frames 160. For example, the sampling engine 124 may perform, based on the diffusion model 110, multiple diffusion sampling operations on the latent representation frames 140 to obtain the output latent representation frames 160. The output latent representation frames 160 may include a first output latent frame 162 that is generated based on the first latent frame 142, and a second output latent frame 164 that is generated based on the second latent frame 144.

Each sampling step of the sampling engine 124 may be configured to perform a diffusion sampling step (e.g., a diffusion operation) using the diffusion model 110. For example, in the simplified example in which the sampling engine 124 only performs two sampling steps to generate the first output latent frame 162 as depicted in FIG. 1, the first sampling step 132 receives the first latent frame 142 and uses the diffusion model 110 to generate an output that is provided to the second sampling step 134. The second sampling step 134 receives the output from the first sampling step 132 and uses the diffusion model 110 to generate the first output latent frame 162. To generate the second output latent frame 164, the first sampling step 132 receives the second latent frame 144 and uses the diffusion model 110 to generate an output that is provided to the second sampling step 134. The second sampling step 134 receives the output from the first sampling step 132 and uses the diffusion model 110 to generate the second output latent frame 164. However, it should be understood that in other examples the sampling engine 124 performs more than two sampling steps, such as 10, 20, 100, or any other number of sampling steps, to generate each of the output latent representation frames 160.

The processors 108 (e.g., the flow engine 126) may obtain activations 150 from the sampling engine 124. To illustrate, the sampling engine 124 may generate the activations 150 as part of performing the multiple diffusion sampling steps based on the latent representation frames 140. In some examples, for each latent representation frame of the latent representation frames 140, the sampling engine 124 may generate activations for at least one diffusion sampling step. For example, the sampling engine 124 may generate first activations 152 based on the multiple diffusion sampling steps performed based on the first latent frame 142, and generate second activations 154 based on the multiple diffusion sampling steps performed on the second latent frame 144.

In some embodiments, the first activations 152 (associated with the first latent frame 142) may include one or more activations generated by the first sampling step 132, one or more activations generated by the second sampling step 134, or a combination thereof. In some examples, the one or more activations (associated with the first latent frame 142) generated by the first sampling step 132 include activations generated by a first block of the diffusion model 110 used by the first sampling step 132, activations generated by a second block of the diffusion model 110 used by the first sampling step 132, or a combination thereof. Additionally, or alternatively, the one or more activations (associated with the first latent frame 142) generated by the second sampling step 134 include activations generated by a first block of the diffusion model 110 used by the second sampling step 134, activations generated by a second block of the diffusion model 110 used by the second sampling step 134, or a combination thereof. In some examples, the first activations 152 associated with the first latent frame 142 include multiple activations from the sampling engine 124. The multiple activations of the first activations 152 may include activations that have the same resolution and/or may include at least two activations that have different resolutions.

In some embodiments, the second activations 154 (associated with the second latent frame 144) may include one or more activations generated by the first sampling step 132, one or more activations generated by the second sampling step 134, or a combination thereof. In some examples, the one or more activations (associated with the second latent frame 144) generated by the first sampling step 132 include activations generated by a first block of the diffusion model 110 used by the first sampling step 132, activations generated by a second block of the diffusion model 110 used by the first sampling step 132, or a combination thereof. Additionally, or alternatively, the one or more activations (associated with the second latent frame 144) include activations generated by a first block of the diffusion model 110 used by the second sampling step 134, activations generated by a second block of the diffusion model 110 used by the second sampling step 134, or a combination thereof. In some examples, the second activations 154 associated with the second latent frame 144 include multiple activations from the sampling engine 124. The multiple activations of the second activations 154 may include activations that have the same resolution and/or may include at least two activations that have different resolutions.

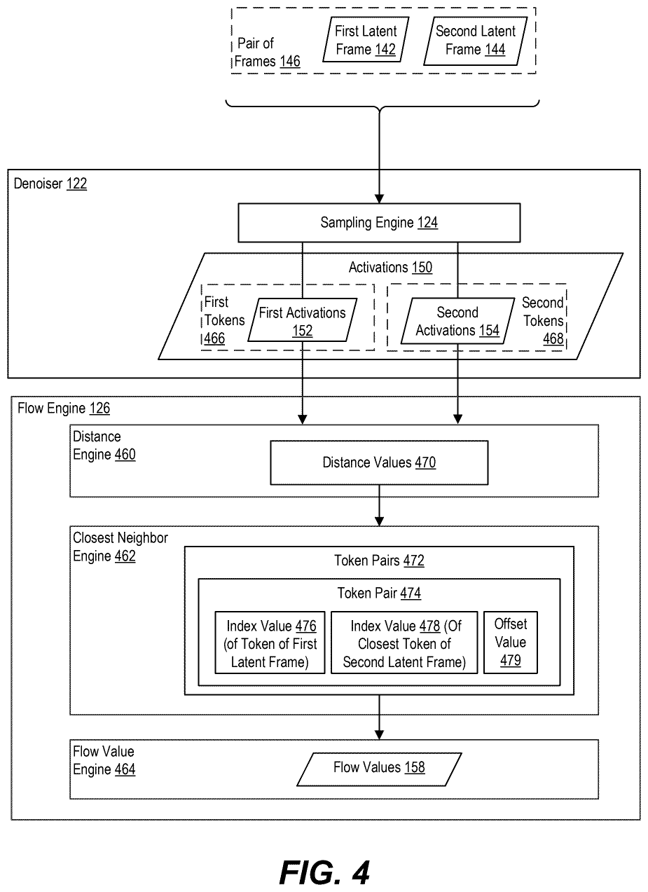

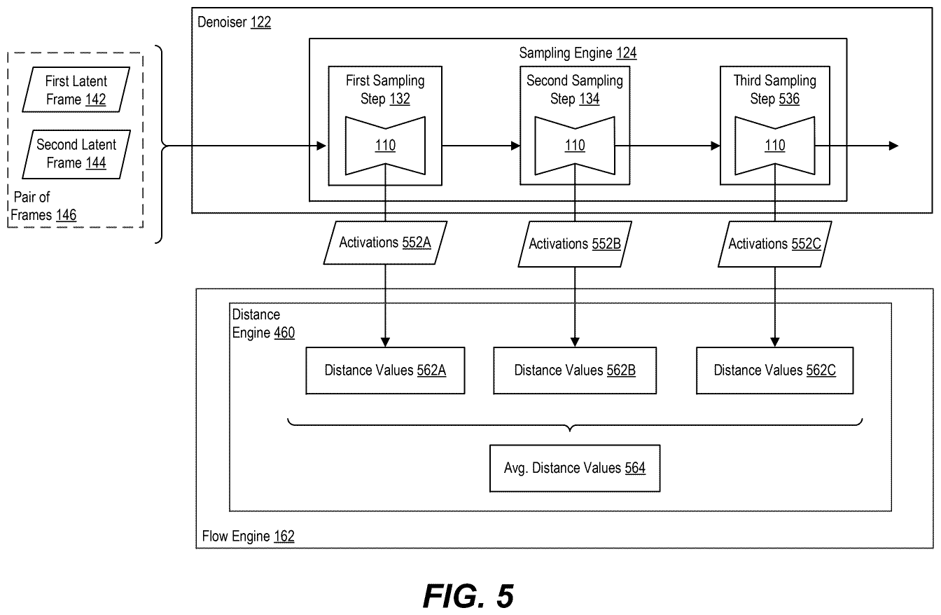

The flow engine 126 may determine the flow values 158 based on the activations 150 obtained by the flow engine 126. Operations of the flow engine 126 are described further herein at least with reference to FIGS. 4 and 5. In some examples, the flow engine 126 determines the flow values 158 based on diffusion sampling operations performed on the pair of latent representation frames 146. In a particular aspect, the flow engine 126 determines the flow values 158 based on the activations 150 obtained for the pair of latent representation frames 146—e.g., based on the first activations 152 for the first latent frame 142 and the second activations 154 for the second latent frame 144. The flow values 158 may be associated with a flow map that represents a flow of the pair of latent representation frames 146. It is noted that the activations 150 used by the flow engine 126 may not all have the same resolution. Accordingly, the flow engine 126 may upscale or downscale one or more activations (of the activations 150) so that the activations 150 are the same resolution.

Referring to FIG. 4, FIG. 4 is a diagram of an illustrative aspect of operations associated with the system of FIG. 1, in accordance with some examples of the present disclosure. FIG. 4 shows the denoiser 122 and the flow engine 126 of the system 100. The flow engine 126 includes a distance engine 460, a closest neighbor engine 462, and a flow value engine 464.

As explained with reference to FIG. 1, the pair of latent representation frames 146, including the first latent frame 142 and the second latent frame 144, are received by the denoiser 122 (e.g., the sampling engine 124). Each latent frame of the pair of latent representation frames 146 is associated with a set of tokens. The sampling engine 124 of the denoiser 122 generates the activations 150 that include the first activations 152 associated with the first latent frame 142, and the second activations 154 associated with the second latent frame 144. The first activations 152 are associated with first tokens 466 that correspond to the first latent frame 142, and the second activations 154 are associated with second tokens 468 that correspond to the second latent frame 144.

The flow engine 126 (e.g., the distance engine 460) receives the activations 150. The distance engine 460 is configured to determine, for the pair of latent representation frames 146, distance values 470 based on the activations 150. The distance values 470 may be associated with the first tokens 466 associated the first latent frame 142 and the second tokens 468 associated with the second latent frame 144. To determine the distance values 470, the distance engine 460 (e.g., the processor 108 of the system 100) determines a cosine distance based on the first activations 152 obtained for the first latent frame 142 and the second activations 154 obtained for the second latent frame 144. In some examples, the first activations 152 and the second activations 154 are obtained from the same sampling step and from the same block of the diffusion model 110. The distance values 470 may be logically arranged or structured in a first dimension according to index values of the first tokens 466 and in a second dimension according to index values of the second tokens 468.

In some examples, the distance values 470 includes average distance values, as described further herein with reference to FIG. 5. Referring to FIG. 5, FIG. 5 shows the denoiser 122 and the flow engine 126 of the system 100. The denoiser 122 includes the sampling engine 124. The multiple sampling steps of the sampling engine 124 include the first sampling step 132, the second sampling step 134, and a third sampling step 536. The third sampling step 536 is configured to perform one or more operations as described with reference to the first sampling step 132 or the second sampling step 134.

The flow engine 126 includes the distance engine 460. The flow engine 126 (e.g., the distance engine 460) obtains activations 552 from each of the multiple sampling steps 132, 134, and 536 of the sampling engine 124. For example, the distance engine 460 receives activations 552A from the first sampling step 132, activations 552B from the second sampling step 134, and activations 552C from the third sampling step 536. Each of the activations 552 may include activations for the first latent frame 142 and activations for the second latent frame 144. For each of the activations 552, the activations for the first latent frame 142 and the activations for the second latent frame 144 that are obtained from the same sampling step are also obtained from the same block of the diffusion model 110 of the respective sampling step. Although the activations 552 are described as being obtained from each sampling step of the multiple sampling steps of the sampling engine 124, in other implementations, the activations 552 may be obtained from a single sampling step or from less than all of the sampling steps. Additionally, or alternatively, although the activations 552 are described as including three activations 552A-C, in other implementations, the activations 552 may include two or more activations 552.

For the pair of latent representation frames 146, the distance engine 460 determines, for each of the activations 552, corresponding distance values 562. The distance values 470 may be associated with the first tokens 466 (associated with the first latent frame 142) and the second tokens 468 (associated with the second latent frame 144). To determine the distance values 562, the distance engine 460 (e.g., the processor 108 of the system 100) determines a cosine distance based on activations 552. To illustrate, to determine the distance values 562A, the distance engine 460 determines a cosine distance based on the activations of the first latent frame 142 included in the activations 552A, and the activations of the second latent frame 144 included in the activations 552A. To determine the distance values 562B, the distance engine 460 determines a cosine distance based on the activations of the first latent frame 142 included in the activations 552B, and the activations of the second latent frame 144 included in the activations 552B. To determine the distance values 562C, the distance engine 460 determines a cosine distance based on the activations of the first latent frame 142 included in the activations 552C, and the activations of the second latent frame 144 included in the activations 552C. The distance values 562 may be logically arranged or structured in a first dimension according to index values of the first tokens 466 and in a second dimension according to index values of the second tokens 468.

For the pair of latent representation frames 146, the distance engine 460 determines average distance values 564 based on the distance values 562. The average distance values 564 may be logically arranged or structured in a first dimension according to index values of the first tokens 466 and in a second dimension according to index values of the second tokens 468. In some examples, the average distance values 564 is determined as a weighted average of the distance values 562.

Referring back to FIG. 4, the distance values 470 (or the average distance values 564) are provided to the closest neighbor engine 462. The closest neighbor engine 462 determines, for the pair of latent representation frames 146, multiple token pairs 472 based on the distance values (or the average distance values 564). For example, the multiple token pairs 472 include a representative token pair 474. The token pair 474 includes an index value 476 (of a token of the first latent frame 142), an index value 478 (of a closest token of the second latent frame 144), and an offset value 479. As used in the context of FIG. 4, “closest” refers to similarity (e.g., cosine distance). In a particular embodiment, a “closest neighbor” to a particular token of frame i is a token of neighboring frame j having a closest similarity to the value of the particular token of frame i, which may, but does not necessarily, have the same or similar token position (e.g., index value) in frame j as the particular token does in frame i.

To determine the multiple token pairs 472 (e.g., the token pair 474), the closest neighbor engine 462 identifies a first index value (e.g., 476) of the first tokens 466. For the identified first index value (e.g., 476), the closest neighbor engine 462 identifies, based on the distance values 470 (or the average distance values 564), a shortest distance value for the first index value, and based on the identified shortest distance value, identifies a second index value (e.g., 478) of a token of the second tokens 468. The closest neighbor engine 462 determines an offset value (e.g., 479) based on the first index value and the second index value.

The flow value engine 464 receives the token pairs 472. For each token pair, the flow value engine 464 determines, based on the offset values (e.g., 479) of the token pair, a flow value for the token (e.g., 476) of the first tokens 466. The flow values 158 determined based on the token pairs 472 may indicate motion associated with the pair of latent representation frames 146.

Referring back to FIG. 1, the processor 108 (e.g., the video generator 120) may use the flow values 158 (e.g., the latent flow). For example, the video generator 120 may perform one or more operations (e.g., a video generation operation), such as warping or alignment, to generate a video output.

In some implementations, the one or more operations may be performed by the denoiser 122. To illustrate, the flow engine 126 may determine the flow values based on a first set of diffusion sampling operations performed on the latent representation frames 140 (e.g., the pair of latent representation frames 146). The flow engine 126 may provide the flow values 158 to the denoiser 122 and the denoiser 122 may perform the one or more operations (e.g., the video generation operation) in association with a second set of diffusion sampling operations of the multiple diffusion sampling operations. The second set of diffusion sampling operations may be subsequent to the first set of diffusion sampling operations. In such implementations, the denoiser 122 (e.g., the sampling engine 124) may perform the first set of diffusion sampling operations to enable the flow engine 126 to determine the flow values 158, and may perform the second set of diffusion sampling operations to use the flow values 158 to perform the video generation operation, such as a warping operation. The video generation operation, such as the warping operation, may provide a latent-flow based regularization of two or more layers (or all the layers) that may increase temporal motion consistencies associated with motions consistent with the latent flow.

In some implementations, the processor 108 (e.g., the video generator 120) may also include a decoder, as described further herein at least with reference to FIG. 6. For example, the processor 108 (e.g., the video generator 120) may include the decoder that is configured to decode the output latent representation frames 160 to generate output image frames.

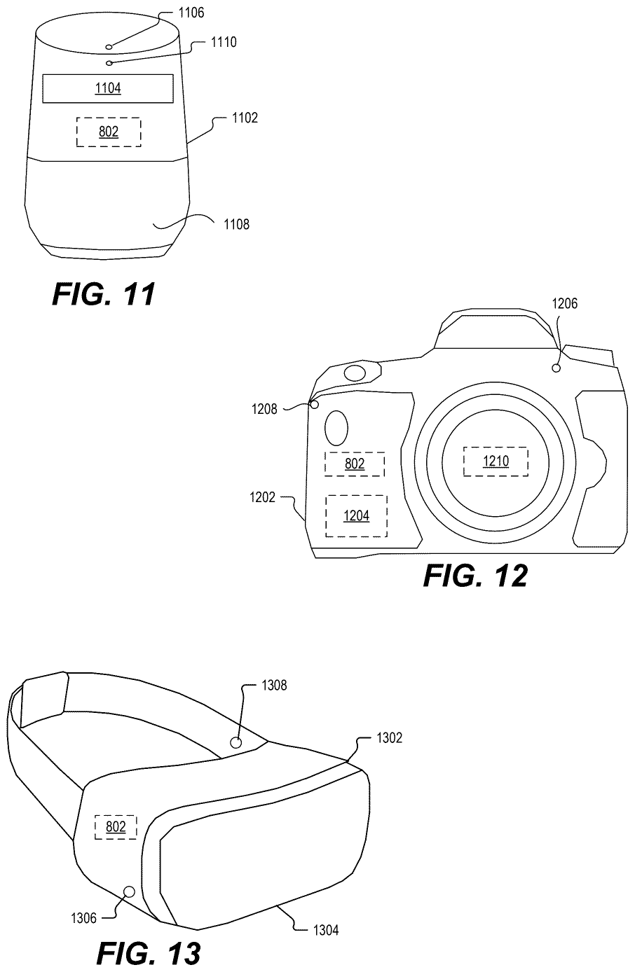

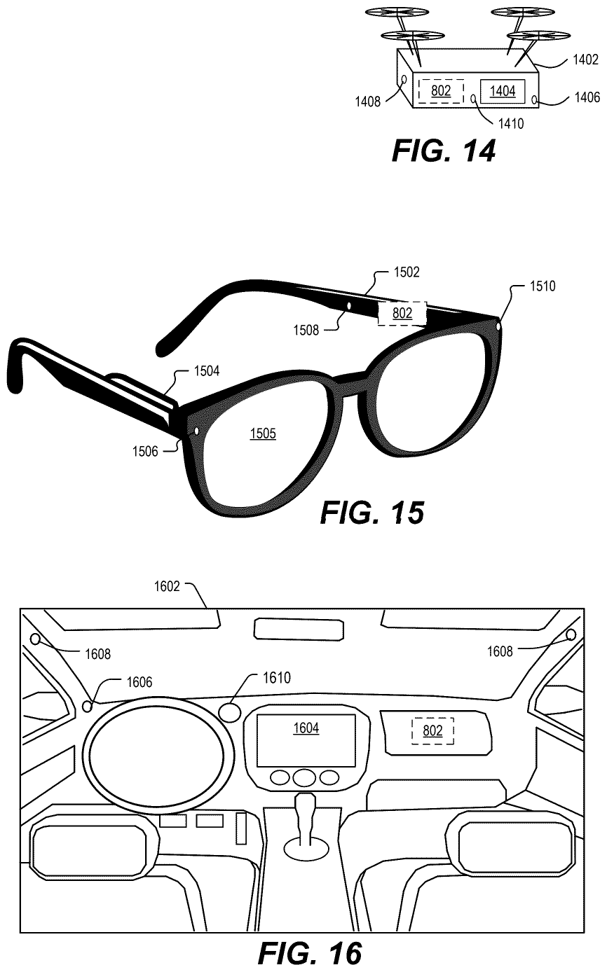

In some examples, the device 102 corresponds to or is included in one of various types of devices, such that the processor 108 can be integrated in multiple types of devices. In an illustrative example, the processor 108 is integrated in a wearable device, such as a wearable electronic device as depicted in 10, a virtual reality, mixed reality, or augmented reality headset as depicted in FIG. 13, a mixed reality or augmented reality glasses device as described with reference to FIG. 15, or another wearable device. In another illustrative example, the processor 108 is integrated in a mobile device (e.g., a mobile phone or a tablet) as depicted in FIG. 9, a voice-controlled speaker system as depicted in FIG. 11, a camera as depicted in FIG. 12, a vehicle as depicted in FIG. 14 or FIG. 16, a computer or a server, or another system or device.

One technical advantage of implementing the device 102 as described above is that motion extraction can be performed on the diffusion model 110 to determine the flow values 158 (e.g., latent flows). The motion extraction may advantageously leverage the activations 150 generated using the diffusion model 110 and therefore provide little or no additional cost in terms of hardware, computational power consumption, processing delay, or latency, to determine the flow values 158. The flow values 158 (e.g., latent flows) are fast to compute and may be used by the video generator 120 to improve video generation. For example, flow values 158 (e.g., latent flows) may be effective for warping in the latent space.

FIG. 6 is a block diagram of a particular illustrative aspect of a system 600 that is operable to generate flow values associated with a diffusion model, in accordance with some examples of the present disclosure. The system 600 includes a device 602 that may include or correspond to the device 102 of FIG. 1.

The device 602 includes the memory 106, the processor 108, and a modem 618. The modem 618 is coupled to the processor 108 and is configured to transmit video content (e.g., output image frames 690) generated based on multiple image frames (e.g., input image frames 680) to a second device for output by the second device, receive video content (e.g., the input image frames 680) from a second device for processing and playback at the device 602, or both. The memory 106 is configured to store the diffusion model 110 and instructions 612. The instructions 612, when executed by the processor 108, cause the processor 108 to perform one or more operations as described herein.

The processor 108 is also coupled to an image sensor 604, an input device 614 (e.g., a microphone, a keyboard or touch screen, etc.), a display device 619, and a speaker 621. The image sensor 604 may include one or more cameras and may be configured to generate multiple image frames, such as the input image frames 680 that include a first input frame 682 and a second input frame 864. Video content, such as the output image frames 690 including a first output frame 692 and a second output frame 694, may be generated by the processor 108 at least partially based on the input image frames 680. The input device 614 is configured to receive an input and provide the input to the processor 108 as input data 615. For example, the input device 614 may include a keyboard, a touch screen, or a microphone configured to receive the input and provide the input data 615 (e.g., an input signal) to the processor 108. In some embodiments, the input may be received based on or in association with a prompt. The input (e.g., the input data 615) may include or indicate a request to generate output video content, such as a request to generate the output image frames 690 based on the diffusion model 110 and the input image frames 680. In some examples, the input includes a request to perform a text-based video generation, a text-based video content editing operation, a video enhancement operation, video compression, a data augmentation operation, or a combination thereof.

The display device 619 is coupled to the processor 108 and is configured to output the output image frames 690 generated based on the input image frames 680. In some examples, the display device 619 includes a display screen, a monitor or television, a projector, or a combination thereof. In some embodiments, the device 602 may include or be couped to the processor 108 and is configured to output audio associated with video content (e.g., the output image frames 690) generated based on the input image frames 680.

The image sensor 604, the input device 614, the display device 619, the speaker 621, or a combination thereof may be coupled to or integrated within the device 602. Although the device 602 is described as being coupled to or including the image sensor 604, the input device 614, the modem 618, the display device 619, and the speaker 621, in other embodiments the device 602 may not include or be coupled to the image sensor 604, the input device 614, the modem 618, the display device 619, the speaker 621, or a combination thereof.

The processor 108 of FIG. 6 includes the video generator 620. The video generator 620 may include or correspond to the video generator 120. The video generator 620 includes an encoder 630, the denoiser 122 (having the sampling engine 124), the flow engine 126, and a decoder 632. The encoder 630 is configured to receive the input image frames 680 and generate the latent representation frames 140 based on the input image frames 680. For example, the encoder 630 may include a neural network configured to extract latents (e.g., low dimensional representations). In some such examples, the encoder 630 performs one or more operations to compress the input image frames 680 into the latent space. To illustrate, the encoder 630 receives the first input frame 682 and performs the one or more operations to generate the first latent frame 142. Additionally, or alternatively, the encoder 630 receives the second input frame 684 and performs the one or more operations to generate the second latent frame 144. In some examples, the encoder 630 is, includes, or is included in a variational autoencoder (VAE). In some embodiments, the encoder 630 maps pixels X of the input image frames 680 to latents Z. For example, the encoder 630 can map the pixels X∈R^{c×H×W} to latents Z∈R^{c×h×w} where R is a set of frames, c is a channel number/index, h and H are heights, and w and W are widths. It is noted that h and w are usually a multiple (e.g., 4 times) smaller than H and W.

The denoiser 122 receives the latent representation frames 140 and performs a denoising diffusion operation using the sampling engine 124 and the diffusion model 110, as described at least with reference to FIGS. 1-4. The denoiser 122 outputs, in the latent space, the output latent representation frames 160 generated based on the latent representation frames 140. Additionally, the flow engine 126 generates the flow values 158 based on activations obtained from the denoiser 122 (e.g., the sampling engine 124), as described at least with reference to FIGS. 1-4. The video generator 620 (e.g., the denoiser 122) may perform one or more operations based on the flow values 158, such as a warping or aligning operation in the latent space.

The decoder 632 receives the output latent representation frames 160 and decodes the output latent representation frames 160 to generate the output image frames 690 that include the first output frame 692 and the second output frame 694. For example, the decoder 632 may decode the first output latent frame 162 to generate the first output frame 692. Additionally, or alternatively, the decoder 632 may decode the second output latent frame 164 to generate the second output frame 694. In some examples, the decoder 632 is, includes, or is included in a VAE.

The device 602 including the video generator 620 enables implementation of the flow engine 126 as a component in a system or a device. For example, the system or the device may include a mobile device (e.g., a mobile phone or tablet) as depicted in FIG. 9, a wearable electronic device as depicted in FIG. 10, a voice-controlled speaker system as depicted in FIG. 11, a camera device as depicted in FIG. 12, a virtual reality, mixed reality, or augmented reality headset as depicted in FIG. 13, a mixed reality or augmented reality glasses device, as described with reference to FIG. 15, earbuds, or a vehicle as depicted in FIG. 14 or FIG. 16.

In some examples, the device 602 corresponds to or is included in one of various types of devices, such that the processor 108 can be integrated in multiple types of devices. In an illustrative example, the processor 108 of the device 602 is integrated in a wearable device, such as a wearable electronic device as depicted in 10, a virtual reality, mixed reality, or augmented reality headset as depicted in FIG. 13, a mixed reality or augmented reality glasses device as described with reference to FIG. 15, or another wearable device. In another illustrative example, the processor 108 is integrated in a mobile device (a mobile phone or a tablet) as depicted in FIG. 9, a voice-controlled speaker system as depicted in FIG. 11, a camera as depicted in FIG. 12, a vehicle as depicted in FIG. 14 or FIG. 16, a computer or a server, or another system or device.

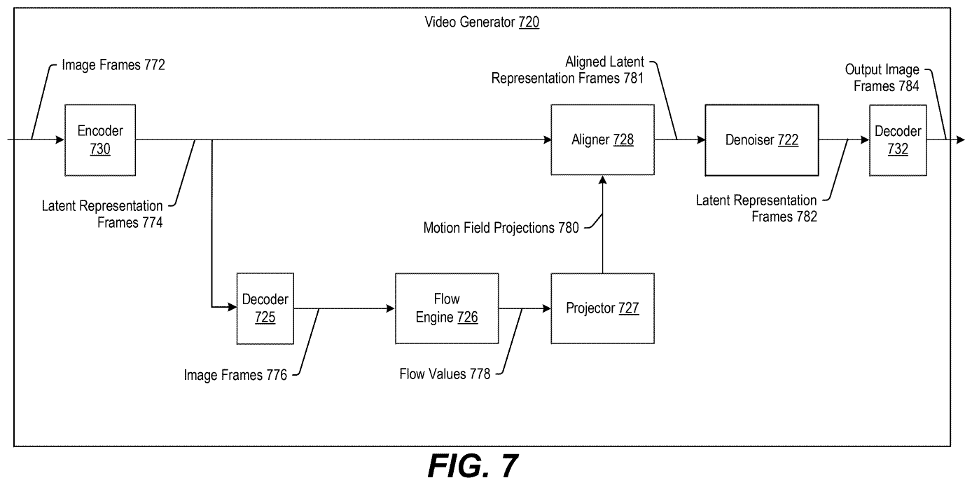

FIG. 7 is a block diagram of a particular illustrative aspect of a video generator 720 that is operable to generate flow values associated with a diffusion model, in accordance with some examples of the present disclosure. The video generator 720 may be implemented in a device, such as the device 102 or 602. For example, the video generator 720 may be implemented in the device 102 instead of the video generator 120, or implemented in the device 602 instead of the video generator 620.

The video generator 720 includes an encoder 730, a decoder 725, a flow engine 726, a projector 727, an aligner 728, a denoiser 722, and a decoder 732. The video generator 720 is configured to receive image frames 772. For example, the image frames 772 are received by the encoder 730. The encoder 730 may include or correspond to the encoder 630. The encoder 730 is configured to receive the image frames 772 and generate latent representation frames 774 based on the image frames 772. The image frames 772 and the latent representation frames 774 may include or correspond to the input image frames 680 and the latent representation frames 140, respectively.

The decoder 725 may receive the latent representation frames 774. The decoder 725 is configured to decode the latent representation frames 774 and generate image frames 776 based on the latent representation frames 774. The image frames 776 may be provided to the flow engine 726. Although the image frames 776 are described as being provided to the flow engine 726, in other implementations, the image frames 772 may be provided to the flow engine 726 such that the video generator 720 does not include the decoder 725.

The flow engine 726 is configured to generate flow values 778 (e.g., motion fields in a pixel-space) based on the image frames 776 (or the image frames 772). In some examples, the flow engine 726 may include a pretrained optical flow model, such as a recurrent all pairs field transform (RAFT) configured to extract motion field from pixels of the image frames 776 (or the image frames 772). The flow values 778 may be provided to the projector 727.

The projector 727 is configured to project the flow values 778 from the pixel space to the latent space. For example, the projector 727 may generate, based on the flow values 778, motion field projections 780 in the latent space.

The aligner 728 may receive the latent representation frames 774 and the motion field projections 780. The aligner 728 is configured to align (warp) the latent representation frames 774 based on the motion field projections 780 to generate aligned latent representation frames 781 (e.g., warped latent representation frames). The aligned latent representation frames 781 are provided to the denoiser 722.

The denoiser 722 may include or correspond to the denoiser 122. The denoiser 722 is configured to generate latent representation frames 782 based on the aligned latent representation frames 781. The latent representation frames 782 may include or correspond to the output latent representation frames 160.

The decoder 732 receives the latent representation frames 782 from the denoiser 722. The decoder 732 may include or correspond to the decoder 632. The decoder 732 may generate output image frames 784 based on the latent representation frames 782. The output image frames 784 may include or correspond to the output image frames 690.

The video generator 720 (e.g., a processor that includes the video generator 720) enables implementation of the flow engine 726 as a component in a system or a device. For example, the system or the device may include a mobile device (e.g., a mobile phone or tablet) as depicted in FIG. 9, a wearable electronic device as depicted in FIG. 10, a voice-controlled speaker system as depicted in FIG. 11, a camera device as depicted in FIG. 12, a virtual reality, mixed reality, or augmented reality headset as depicted in FIG. 13, a mixed reality or augmented reality glasses device, as described with reference to FIG. 15, earbuds, or a vehicle as depicted in FIG. 14 or FIG. 16.

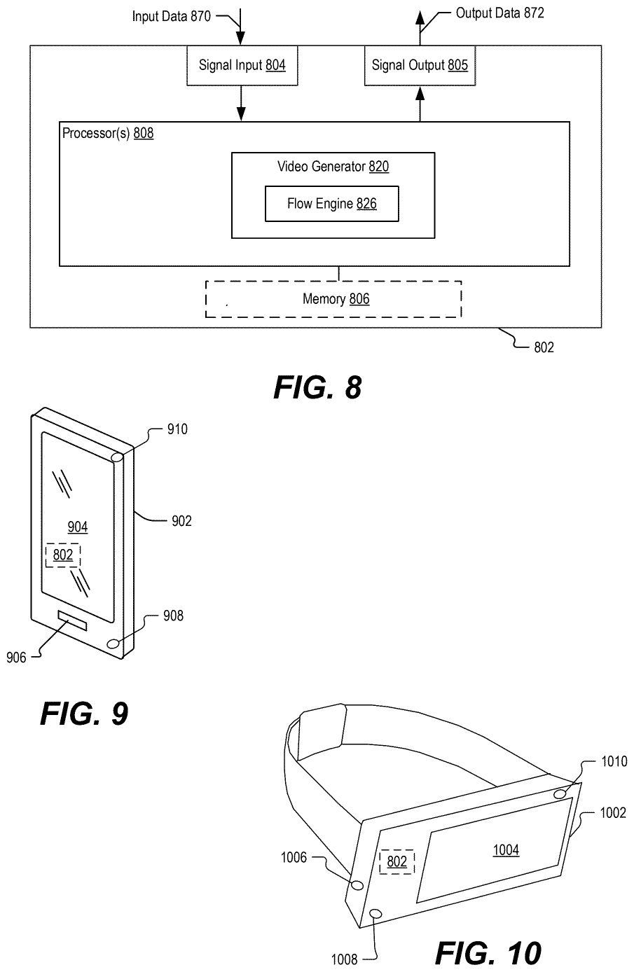

FIG. 8 depicts a diagram of an example of an integrated circuit 802 operable to generate flow values associated with a diffusion model, in accordance with some examples of the present disclosure. The integrated circuit 802 includes one or more processors 808 (herein after referred to as the “processor 808”). The processor 808 may include or correspond to the processor 108. The integrated circuit 802 may optionally (as indicated by a dashed box) include a memory 806. The memory 806 may include or correspond to the memory 106.

The processor 808 may include a video generator 820 having the flow engine 826. The video generator 820 may include or correspond to the video generator 120, 620, or 720. The flow engine 826 may include or correspond to the flow engine 126 or 726.

The integrated circuit 802 also includes a signal input 804, such as one or more bus interfaces, to enable the integrated circuit 802 to receive signals representing input data 870 for processing. For example, the input data 870 can correspond to or include the input image frames 680, the latent representation frames 140, the input data 615, or a combination thereof.

The integrated circuit 802 also includes a signal output 805, such as a bus interface, to enable the integrated circuit 802 to output signals representing output data 872. For example, the output data 872 can correspond to or include the output latent representation frames 160, the output image frames 690, or a combination thereof.

The integrated circuit 802 including the video generator 820 enables implementation of the flow engine 826 as a component in a system or a device. For example, the system or the device may include a mobile device (e.g., a mobile phone or tablet) as depicted in FIG. 9, a wearable electronic device as depicted in FIG. 10, a voice-controlled speaker system as depicted in FIG. 11, a camera device as depicted in FIG. 12, a virtual reality, mixed reality, or augmented reality headset as depicted in FIG. 13, a mixed reality or augmented reality glasses device, as described with reference to FIG. 15, earbuds, or a vehicle as depicted in FIG. 14 or FIG. 16.

In some implementations, the system or the device that includes the integrated circuit 802 also includes or is coupled to an image sensor, an input device (e.g., a microphone, a keyboard or touch screen, etc.), a display device, a speaker, or a combination thereof. For example, the image sensor, the input device, the display device, and the speaker may include or correspond to the image sensor 604, the input device 614, the display device 619, and the speaker 621, respectively.

FIG. 9 depicts a diagram of a mobile device 902 operable to generate flow values associated with a diffusion model, in accordance with some examples of the present disclosure. The mobile device 902 may include or correspond to a phone or a tablet, as illustrative, non-limiting examples. The mobile device 902 includes a display 904 (e.g., a display screen), a microphone 906, a speaker 908, a camera 910 (e.g., an image sensor), and the integrated circuit 802. Components of the integrated circuit 802, including the video generator 820, are integrated in the mobile device 902 and are illustrated using dashed lines to indicate internal components that are not generally visible to a user of the mobile device 902.

FIG. 10 depicts a diagram of a wearable electronic device 1002 operable to generate flow values associated with a diffusion model, in accordance with some examples of the present disclosure. The wearable electronic device 1002 may include or correspond to a “smart watch,” as an illustrative, non-limiting example. The wearable electronic device 1002 includes a display 1004 (e.g., a display screen), a microphone 1006, a speaker 1008, a camera 1010 (e.g., an image sensor), and the integrated circuit 802. Components of the integrated circuit 802, including the video generator 820, are integrated in the wearable electronic device 1002.

FIG. 11 is a diagram of a voice-controlled speaker system 1102 operable to generate flow values associated with a diffusion model, in accordance with some examples of the present disclosure. The voice-controlled speaker system 1102 may include or correspond to a wireless speaker and voice activated device, as an illustrative, non-limiting example. The voice-controlled speaker system 1102 can have wireless network connectivity and is configured to execute an assistant operation. The wireless speaker and voice activated device 1102 includes a display 1104 (e.g., a display screen), a microphone 1106, a speaker 1108, a camera 1110 (e.g., an image sensor), and the integrated circuit 802. Components of the integrated circuit 802, including the video generator 820, are integrated in the voice-controlled speaker system 1102.

FIG. 12 is a diagram of a camera device 1202 operable to generate flow values associated with a diffusion model, in accordance with some examples of the present disclosure. The camera device 1202 includes a display 1204 (e.g., a display screen), a microphone 1206, a speaker 1208, an image sensor 1210, and the integrated circuit 802. Components of the integrated circuit 802, including the video generator 820, are integrated in the camera device 1202.

FIG. 13 is a diagram of a headset 1302, such as a virtual reality, mixed reality, or augmented reality headset, operable to generate flow values associated with a diffusion model, in accordance with some examples of the present disclosure. A visual interface device is positioned in front of the user's eyes to enable display of augmented reality, mixed reality, or virtual reality images or scenes to the user while the headset 1302 is worn. The headset 1302 also includes a display 1304 (e.g., a display screen), a microphone 1306, a speaker 1308, and the integrated circuit 802. Components of the integrated circuit 802, including the video generator 820, are integrated in the headset 1302.

FIG. 14 is a diagram of a first example of a vehicle 1402 operable to generate flow values associated with a diffusion model, in accordance with some examples of the present disclosure. The vehicle 1402 may include or correspond to a manned or unmanned aerial device (e.g., a package delivery drone). The vehicle 1402 includes a display 1404 (e.g., a display screen), a microphone 1406, a speaker 1408, a camera 1410 (e.g., an image sensor), and the integrated circuit 802. Components of the integrated circuit 802, including the video generator 820, are integrated in the vehicle 1402.

FIG. 15 is a diagram of a mixed reality or augmented reality glasses device 1502 operable to generate flow values associated with a diffusion model, in accordance with some examples of the present disclosure. The glasses 1502 include a holographic projection unit 1504 configured to project visual data onto a surface of a lens 1505 or to reflect the visual data off of a surface of the lens 1505 and onto the wearer's retina. The glasses 1502 also include a microphone 1506, a speaker 1508, a camera 1510 (e.g., an image sensor), and the integrated circuit 802. Components of the integrated circuit 802, including the video generator 820, are integrated in the glasses 1502.

FIG. 16 is a diagram of a second example of a vehicle 1602 operable to generate flow values associated with a diffusion model, in accordance with some examples of the present disclosure. The vehicle 1602 may include or correspond to a car. The vehicle 1602 includes a display 1604 (e.g., a display screen), a microphone 1606, one or more speakers 1608, a camera 1610 (e.g., an image sensor), and the integrated circuit 802. Components of the integrated circuit 802, including the video generator 820, are integrated in the vehicle 1602.

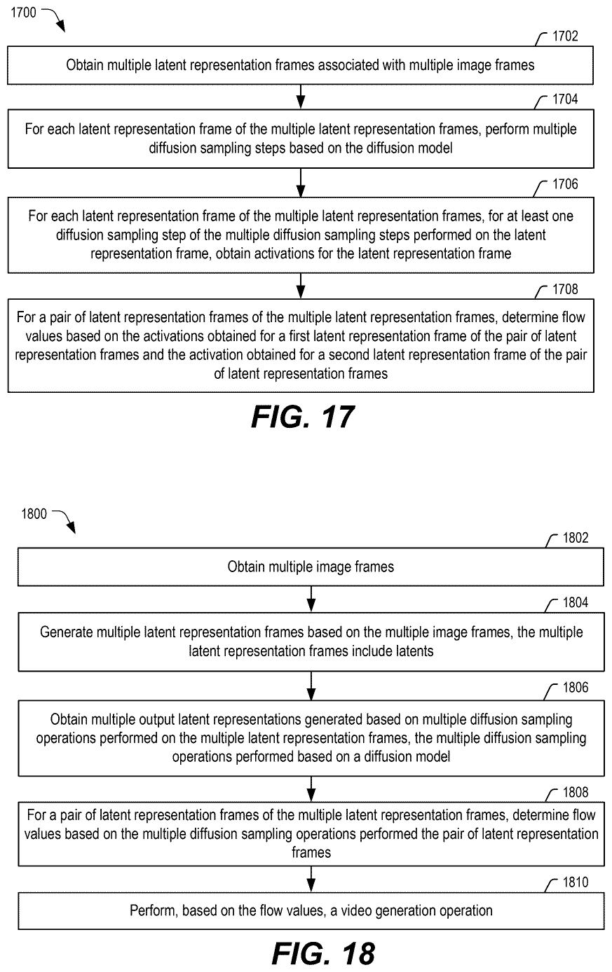

Referring to FIG. 17, a particular implementation of a method 1700 of generation of flow values associated with a diffusion model is shown. In a particular aspect, one or more operations of the method 1700 are performed by the device 102 or 602, the processor 108, the video generator 620, the denoiser 122 and the flow engine 126, the device 102, the system 100 or 600, the integrated circuit 802, or a combination thereof.

In some embodiments, the method 1700 includes, at block 1702, obtaining multiple latent representation frames associated with multiple image frames. The multiple latent representation frames and the multiple image frames may include or correspond to the latent representation frames 140 and the input image frames 680, respectively. The multiple image frames may include a sequence of image frames of video content. In some implementations, the multiple latent representation frames may be received from an encoder, such as an autoencoder. For example, the encoder may receive the multiple image frames and generate the multiple latent representation frames. The encoder may include or correspond to the encoder 630.

In some embodiments, the method 1700 includes obtaining the multiple image frames. For example, the multiple image frames may be received by the processor 108, the video generator, or the encoder 630. The method 1700 may include encoding an image frame of the multiple image frames to generate a latent representation frame of the multiple latent representation frames. The latent representation frame may be generated by the encoder 630 and may include latents that are associated with an array of tokens.

The method 1700 also includes, at block 1704, performing, based on a diffusion model, multiple diffusion sampling operations on the multiple latent representation frames. For example, the diffusion model may include or correspond to the diffusion model 110. The multiple diffusion sampling operations may include or correspond to the sampling engine 124, the first sampling step 132, the second sampling step 134, the third sampling step 536, or a combination thereof. The diffusion model may include an LDM, have a U-Net architecture including a plurality of blocks, include one or more transformers, or a combination thereof.

The method 1700 further includes, at block 1706, for at least one diffusion sampling operation of the multiple diffusion sampling operations, obtaining activations. For example, the activations may include or correspond to the activations 150, the first activations 152, the second activations 154, the activations 342, 344, 345, or 348, the activations 552, or a combination thereof. In some embodiments, the method 1700 includes obtaining the activations from a transformer of one or more transformers of the diffusion model.

The method 1700 includes, at block 1708, for a pair of latent representation frames of the multiple latent representation frames, determining flow values based on the activations obtained for a first latent representation frame of the pair of latent representation frames and the activations obtained for a second latent representation frame of the pair of latent representation frames. For example, the pair of latent representation frames may include or correspond to the pair of frames 146. The flow values may include or correspond to the flow values 158. The flow values may be associated with a flow map that represents a flow of the pair of latent representation frames. In some implementations, the method 1700 may include performing, based on the flow values, a video generation operation on the multiple output image frames. The video generation operation may include or correspond to a warping operation or an aligning operation.

In some implementations, the method 1700 includes obtaining multiple output latent representations generated based on the multiple diffusion sampling operations performed on the multiple latent representation frames. For example, the multiple output latent representations may include or correspond to the output latent representation frames 160. Additionally, or alternatively, the method 1700 may include decoding the multiple output latent representations to generate multiple output image frames. For example, the multiple output image frames may include or correspond to the output image frames 609. The multiple output latent representations may be decoded using a decoder, such as the decoder 632.

In some embodiments, each latent representation frame of the pair of latent representation frames is associated with a plurality of tokens. The plurality of tokens may include or correspond to the first tokens 466, the second tokens 468, or a combination thereof. In some examples, the method 1700 includes determining, for the pair of latent representation frames, a set of distance values based on the activations obtained from the at least one diffusion sampling operation. The set of distance values associated with a first plurality of tokens associated the first latent representation frame and a second plurality of tokens associated with the second latent representation frame. For example, the set of distance values may include or correspond to the distance values 470 or the average distance values 564. To determine the set of distance values, the method 1700 may include determining a cosine distance based on the activations obtained for the first latent representation frame and the activations obtained for the second latent representation frame. Additionally, or alternatively, the set of distance values may be arranged in a first dimension according to index values of the first plurality of tokens and in a second dimension according to index values of the second plurality of tokens.

In some embodiments, the method 1700 includes, for the pair of latent representation frames of the multiple latent representation frames, identifying a first index value of a token of a first plurality of tokens of the first latent representation. Additionally, the method 1700 can also include, for the pair of latent representation frames of the multiple latent representation frames, identifying, based on the set of distance values, a shortest distance value for the first index value of the token of the first plurality of tokens. Based on the identified shortest distance value, the method 1700 identifies a second index value of a token of the second plurality of tokens. The first index value and the second index value may include or correspond to the index value 476 and the index value 478, respectively. In some examples, the method 1700 also includes determining an offset value based on the first index value of the token of the first plurality of tokens and the second index value of the token of the second plurality of tokens. The offset value may include or correspond to the offset value 479. A flow value for the token of the first plurality of tokens may be determined based on the offset value.

In some embodiments, the method 1700 includes, for the pair of latent representation frames and for each sampling operation of at least two sampling operations of the multiple diffusion sampling operations, determining a set of distance values based on the activations obtained from the sampling operation. For example, the set of distance values may include or correspond to the distance values 470 or the average distance value 564. The set of distance values may be associated with the first plurality of tokens and the second plurality of tokens. In some examples, the set of distance values for the pair of latent representations may be based on or include an average (e.g., the average distance values 564) of the multiple sets of distance values.

Referring to FIG. 18, a particular implementation of a method 1800 of generation of flow values associated with a diffusion model is shown. In a particular aspect, one or more operations of the method 1800 are performed by the device 102 or 602, the processor 108, the video generator 620, the denoiser 122 and the flow engine 126, the device 102, the system 100 or 600, the integrated circuit 802, or a combination thereof.

In some embodiments, the method 1800 includes, at block 1802, obtaining multiple image frames. For example, the multiple image frames may include or correspond to the input image frames 680. The multiple image frames may include a sequence of image frames of video content.

The method 1800 also includes, at block 1804, generating multiple latent representation frames based on the multiple image frames, the multiple latent representation frames include latents. For example, the multiple latent representation frames may include or correspond to the latent representation frames 140. The multiple latent representation frames may be generated by an encoder, such as an autoencoder. For example, the encoder may include or correspond to the encoder 630.

The method 1800 further includes, at block 1806, obtaining multiple output latent representations generated based on multiple diffusion sampling operations performed on the multiple latent representation frames. For example, the multiple output latent representations may include or correspond to the output latent representation frames 160. The multiple diffusion sampling operations may include or correspond to the sampling engine 124, the first sampling step 132, the second sampling step 134, the third sampling step 536, or a combination thereof. The multiple diffusion sampling operations may be performed based on a diffusion model. For example, the diffusion model may include or correspond to the diffusion model 110. The diffusion model may include an LDM, have a U-Net architecture including a plurality of blocks, include one or more transformers, or a combination thereof.

The method 1800 includes, at block 1808, for a pair of latent representation frames of the multiple latent representation frames, determining flow values based on the multiple diffusion sampling operations performed the pair of latent representation frames. For example, the pair of latent representation frames and the flow values may include or correspond to the pair of frames 146 and the flow values 158, respectively. The flow values may be associated with a flow map that represents a flow of the pair of latent representation frames.

In some embodiments, the method 1800 includes, for at least one diffusion sampling operation of the multiple diffusion sampling operations, obtaining activations. For example, the activations may include or correspond to the activations 150, the first activations 152, the second activations 154, the activations 342, 344, 345, or 348, the activations 552, or a combination thereof. In some embodiments, the method 1800 includes obtaining the activations from a transformer of one or more transformers of the diffusion model. In some examples, the method 1800 may include, for the pair of latent representation frames of the multiple latent representation frames, determining the flow values based on first activations obtained for a first latent representation frame of the pair of latent representation frames and second activations obtained for a second latent representation frame of the pair of latent representation frame. The first activations and the second activations may include or correspond to the first activations 152 and the second activations 154, respectively.

In some embodiment, the method 1800 includes decoding the multiple output latent representations to generate multiple output image frames. The multiple output image frames may include or correspond to the output image frames 690.

The method 1800 includes, at block 1810, performing, based on the flow values, a video generation operation. The video generation operation may include or correspond to a warping operation or an aligning operation. In some embodiments, the flow values are based on a first set of diffusion sampling operations of the multiple diffusion sampling operations performed on the multiple latent representation frames, and the video generation operation is performed in association with a second set of diffusion sampling operations of the multiple diffusion sampling operations.

In some embodiments, each latent representation frame of the pair of latent representation frames is associated with a plurality of tokens. The plurality of tokens may include or correspond to the first tokens 466, the second tokens 468, or a combination thereof. In some examples, the method 1800 includes determining, for the pair of latent representation frames, a set of distance values based on the activations obtained from the at least one diffusion sampling operation. The set of distance values associated with a first plurality of tokens associated the first latent representation frame and a second plurality of tokens associated with the second latent representation frame. For example, the set of distance values may include or correspond to the distance values 470 or the average distance values 564. To determine the set of distance values, the method 1800 may include determining a cosine distance based on the activations obtained for the first latent representation frame and the activations obtained for the second latent representation frame. Additionally, or alternatively, the set of distance values may be arranged in a first dimension according to index values of the first plurality of tokens and in a second dimension according to index values of the second plurality of tokens.

In some embodiments, the method 1800 includes, for the pair of latent representation frames of the multiple latent representation frames, identifying a first index value of a token of a first plurality of tokens of the first latent representation. Additionally, the method 1800 can also include, for the pair of latent representation frames of the multiple latent representation frames, identifying, based on the set of distance values, a shortest distance value for the first index value of the token of the first plurality of tokens. Based on the identified shortest distance value, the method 1800 identifies a second index value of a token of the second plurality of tokens. The first index value and the second index value may include or correspond to the index value 476 and the index value 478, respectively. In some examples, the method 1800 also includes determining an offset value based on the first index value of the token of the first plurality of tokens and the second index value of the token of the second plurality of tokens. The offset value may include or correspond to the offset value 479. A flow value for the token of the first plurality of tokens may be determined based on the offset value.

In some embodiments, the method 1800 includes, for the pair of latent representation frames and for each sampling operation of at least two sampling operations of the multiple diffusion sampling operations, determining a set of distance values based on the activations obtained from the sampling operation. For example, the set of distance values may include or correspond to the distance values 470 or the average distance value 564. The set of distance values may be associated with the first plurality of tokens and the second plurality of tokens. In some examples, the set of distance values for the pair of latent representations may be based on or include an average (e.g., the average distance values 564) of the multiple sets of distance values.

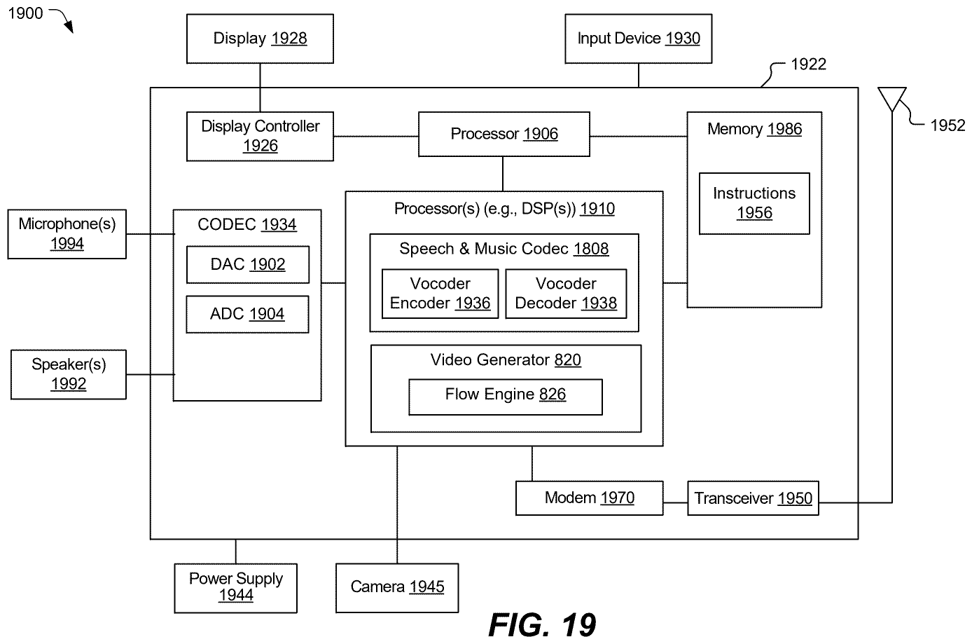

The method 1700 of FIG. 17 or the method 1800 of FIG. 18 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1700 of FIG. 17 or the method 1800 of FIG. 18 may be performed by a processor that executes instructions, such as described with reference to FIG. 19.

It is noted that one or more blocks (or operations) described with reference to FIGS. 17 and 18 may be combined with one or more blocks (or operations) described with reference to another of the figures. For example, one or more blocks (or operations) of FIG. 17 may be combined with one or more blocks (or operations) of FIG. 18. As another example, one or more blocks associated with FIG. 17 or 18 may be combined with one or more blocks (or operations) associated with FIGS. 1-16. Additionally, or alternatively, one or more operations described above with reference to FIGS. 1-18 may be combined with one or more operations described with reference to FIG. 19.

Referring to FIG. 19, FIG. 19 is a block diagram of a particular illustrative example of a device 1900 operable to generate flow values associated with a diffusion model, in accordance with some examples of the present disclosure. In various implementations, the device 1900 may have more or fewer components than illustrated in FIG. 19. In an illustrative implementation, the device 1900 may correspond to the device 102. In an illustrative implementation, the device 1900 may perform one or more operations described with reference to FIGS. 1-18.

In a particular implementation, the device 1900 includes a processor 1906 (e.g., a central processing unit (CPU)). The device 1900 may include one or more additional processors 1910 (e.g., one or more DSPs). In a particular aspect, the processor 108 of FIG. 1 corresponds to the processor 1906, the processors 1910, or a combination thereof. The processors 1910 may include a speech and music coder-decoder (CODEC) 1908 that includes a voice coder (“vocoder”) encoder 1936, a vocoder decoder 1938, the video generator 820, or a combination thereof. The video generator 820 includes or corresponds to the video generator 120 or 620. The video generator 820 includes a flow engine 826. The flow engine 826 includes or corresponds to the flow engine 126 or 726, the distance engine 460, the closest neighbor engine 462, the flow value engine 464, or a combination thereof.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 1900 may include a memory 1986 and a CODEC 1934. The memory 1986 may include instructions 1956, that are executable by the one or more additional processors 1910 (or the processor 1906) to implement the functionality described with reference to the video generator 820, the flow engine 826, or both. The device 1900 may include the modem 1970 coupled, via a transceiver 1950, to an antenna 1952.

The device 1900 may include a display 1928 coupled to a display controller 1926. One or more speakers 1992, the microphone(s) 1994 may be coupled to the CODEC 1934. The CODEC 1934 may include a digital-to-analog converter (DAC) 1902, an analog-to-digital converter (ADC) 1904, or both. In a particular implementation, the CODEC 1934 may receive analog signals from the microphone(s) 1994, convert the analog signals to digital signals using the analog-to-digital converter 1904, and provide the digital signals to the speech and music codec 1908. The speech and music codec 1908 may process the digital signals, and the digital signals may further be processed by the video generator 820. In a particular implementation, the speech and music codec 1908 may provide digital signals to the CODEC 1934. The CODEC 1934 may convert the digital signals to analog signals using the digital-to-analog converter 1902 and may provide the analog signals to the speaker 1992.

In a particular implementation, the device 1900 may be included in a system-in-package or system-on-chip device 1922. In a particular implementation, the memory 1986, the processor 1906, the processors 1910, the display controller 1926, the CODEC 1934, and the modem 1970 are included in the system-in-package or system-on-chip device 1922. In a particular implementation, an input device 1930, a power supply 1944, and a camera 1945 are coupled to the system-in-package or the system-on-chip device 1922. Moreover, in a particular implementation, as illustrated in FIG. 19, the display 1928, the input device 1930, the speaker(s) 1992, the microphone(s) 1994, the antenna 1952, the power supply 1944, and the camera 1945 are external to the system-in-package or the system-on-chip device 1922. In a particular implementation, each of the display 1928, the input device 1930, the speaker(s) 1992, the microphone(s) 1994, the antenna 1952, the power supply 1944, and the camera 1945 may be coupled to a component of the system-in-package or the system-on-chip device 1922, such as an interface or a controller.

The device 1900 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining multiple image frames. For example, the means for obtaining the multiple image frames can include the processor 108, the video generator 120, the denoiser 122, the sampling engine 124, the image sensor 604, the encoder 630, the encoder 730, the integrated circuit 802, the video generator 820, the processor 1906, the processor(s) 1910, the system-in-package or the system-on-chip device 1922, the device 1900, other circuitry configured to obtain the multiple image frames, or a combination thereof.

The apparatus also includes means for generating multiple latent representation frames based on the multiple image frames, the multiple latent representation frames include latents. For example, the means for generating the multiple latent representation frames can include the processor 108, the video generator 120, the denoiser 122, the sampling engine 124, the encoder 630, the encoder 730, the integrated circuit 802, the video generator 820, the processor 1906, the processor(s) 1910, the system-in-package or the system-on-chip device 1922, the device 1900, other circuitry configured to obtain the multiple latent representation frames, or a combination thereof.

The apparatus also includes means for obtaining multiple output latent representations generated based on multiple diffusion sampling operations performed on the multiple latent representation frames, the multiple diffusion sampling operations performed based on a diffusion model. For example, the means for obtaining (the multiple output latent representations) can include the processor 108, the video generator 120, the denoiser 122, the sampling engine 124, the decoder 632, the decoder 732, the integrated circuit 802, the video generator 820, the processor 1906, the processor(s) 1910, the system-in-package or the system-on-chip device 1922, the device 1900, other circuitry configured to obtain the multiple output latent representations, or a combination thereof.

The apparatus further includes means for determining, for a pair of latent representation frames of the multiple latent representation frames, flow values based on the multiple diffusion sampling operations performed the pair of latent representation frames. For example, the means for determining can include the processor 108, the video generator 120, the denoiser 122, the flow engine 126, the flow value engine 464, the integrated circuit 802, the video generator 820, the flow engine 826, the processor 1906, the processor(s) 1910, the system-in-package or the system-on-chip device 1922, the device 1900, other circuitry configured to determine the flow values, or a combination thereof.

The apparatus includes means for performing, based on the flow values, a video generation operation. For example, the means for performing can include the processor 108, the video generator 120, the denoiser 122, the sampling engine 124, the aligner 728, the integrated circuit 802, the video generator 820, the flow engine 826, the processor 1906, the processor(s) 1910, the system-in-package or the system-on-chip device 1922, the device 1900, other circuitry configured to perform the video generation operation, or a combination thereof.

In some implementations, a non-transitory computer-readable medium (e.g., a computer-readable storage device, such as the memory 1986) includes instructions (e.g., the instructions 1956) that, when executed by one or more processors (e.g., the one or more processors 1910 or the processor 1906), cause the one or more processors to obtain multiple image frames, and generate multiple latent representation frames based on the multiple image frames. The multiple latent representation frames include latents. The instructions also cause the one or more processors to obtain multiple output latent representations generated based on multiple diffusion sampling operations performed on the multiple latent representation frames, the multiple diffusion sampling operations performed based on a diffusion model. The instructions cause the one or more processors to, for a pair of latent representation frames of the multiple latent representation frames, determine flow values based on the multiple diffusion sampling operations performed the pair of latent representation frames. The instructions cause the one or more processors to perform, based on the flow values, a video generation operation.

Particular aspects of the disclosure are described below in sets of interrelated Examples:

According to Example 1, a device includes a memory configured to store data corresponding to a diffusion model; and one or more processors coupled to the memory and configured to obtain multiple image frames; generate multiple latent representation frames based on the multiple image frames, the multiple latent representation frames include latents; obtain multiple output latent representations generated based on multiple diffusion sampling operations performed on the multiple latent representation frames, the multiple diffusion sampling operations performed based on the diffusion model; for a pair of latent representation frames of the multiple latent representation frames, determine flow values based on the multiple diffusion sampling operations performed the pair of latent representation frames; and perform, based on the flow values, a video generation operation.

Example 2 includes the device of Example 1, where the multiple image frames include a sequence of image frames of video content.

Example 3 includes the device of Example 1 or Example 2, where the flow values are associated with a flow map that represents a flow of the pair of latent representation frames.

Example 4 includes the device of any of Examples 1-3, where the one or more processors include an autoencoder.

Example 5 includes the device of Example 4, where the one or more processors are configured to generate the multiple latent representation frames based on the autoencoder.

Example 6 includes the device of any of Examples 1-5, where the one or more processors are configured to decode the multiple output latent representations to generate multiple output image frames.

Example 7 includes the device of any of Examples 1-6, where the diffusion model includes a latent diffusion model (LDM).

Example 8 includes the device of any of Examples 1-7, where the diffusion model has a U-Net architecture including a plurality of blocks.

Example 9 includes the device of any of Examples 1-8, where the diffusion model includes one or more transformers.

Example 10 includes the device of any of Examples 1-9, where the video generation operation includes a warping operation.

Example 11 includes the device of any of Examples 1-10, where the one or more processors are configured to, for at least one diffusion sampling operation of the multiple diffusion sampling operations, obtain activations.

Example 12 includes the device of Example 11, where the one or more processors are configured to, for the pair of latent representation frames of the multiple latent representation frames, determine the flow values based on first activations obtained for a first latent representation frame of the pair of latent representation frames and second activations obtained for a second latent representation frame of the pair of latent representation frames.

Example 13 includes the device of any of Examples 1-12, where the flow values are based on a first set of diffusion sampling operations of the multiple diffusion sampling operations performed on the multiple latent representation frames.

Example 14 includes the device of Example 13, where the video generation operation is performed in association with a second set of diffusion sampling operations of the multiple diffusion sampling operations.

Example 15 includes the device of Example 12, where each latent representation frame of the pair of latent representation frames is associated with a plurality of tokens.

Example 16 includes the device of Example 15, where the one or more processors are configured to, for the pair of latent representation frames, determine a set of distance values based on the activations obtained from the at least one diffusion sampling operation.

Example 17 includes the device of Example 16, where the set of distance values associated with a first plurality of tokens associated the first latent representation frame and a second plurality of tokens associated with the second latent representation frame.

Example 18 includes the device of Example 17, where, to determine the set of distance values, the one or more processors are configured to determine a cosine distance based on the activations obtained for the first latent representation frame and the activations obtained for the second latent representation frame.

Example 19 includes the device of Example 18, where the set of distance values are arranged in a first dimension according to index values of the first plurality of tokens and in a second dimension according to index values of the second plurality of tokens.

Example 20 includes the device of Example 18, where the one or more processors are configured to, for the pair of latent representation frames of the multiple latent representation frames, identify a first index value of a token of a first plurality of tokens of the first latent representation frame.

Example 21 includes the device of Example 20, where the one or more processors are configured to, for the pair of latent representation frames of the multiple latent representation frames, identify, based on the set of distance values, a shortest distance value for the first index value of the token of the first plurality of tokens.

Example 22 includes the device of Example 21, where the one or more processors are configured to, for the pair of latent representation frames of the multiple latent representation frames, based on the identified shortest distance value, identify a second index value of a token of the second plurality of tokens.

Example 23 includes the device of Example 22, where the one or more processors are configured to, for the pair of latent representation frames of the multiple latent representation frames, determine an offset value based on the first index value of the token of the first plurality of tokens and the second index value of the token of the second plurality of tokens.

Example 24 includes the device of Example 23, where the one or more processors are configured to, for the pair of latent representation frames of the multiple latent representation frames, determine, based on the offset value, a flow value for the token of the first plurality of tokens.

Example 25 includes the device of Example 15, where the one or more processors are configured to obtain the activations from a transformer of one or more transformers of the diffusion model.

Example 26 includes the device of Example 25, where the first latent representation frame is associated with a first plurality of tokens, and the second latent representation frame is associated with a second plurality of tokens.

Example 27 includes the device of Example 26, where the one or more processors are configured to, for the pair of latent representation frames, and for each sampling operation of at least two sampling operations of the multiple diffusion sampling operations, determine a set of distance values based on the activations obtained from the sampling operation, the set of distance values associated with the first plurality of tokens and the second plurality of tokens.

Example 28 includes the device of Example 27, where the one or more processors are configured to, for the pair of latent representation frames, generate a set of distance values for the pair of latent representations based on an average of the multiple sets of distance values.

Example 29 includes the device of any of Examples 1-28, where the one or more processors are configured to receive an input that includes a request to perform a text-based video generation, a text-based video content editing operation, a video enhancement operation, video compression, a data augmentation operation, or a combination thereof.

Example 30 includes the device of Example 29, where activations are obtained after the input is received.

Example 31 includes the device of any of Examples 1-30, further comprising one or more cameras coupled to the one or more processors and configured to generate the multiple image frames.

Example 32 includes the device of Example 31, and further includes an input device configured to receive an input and provide the input to the one or more processors.

Example 33 includes the device of Example 32, where the input includes a request to generate output video content based on the diffusion model and the multiple image frames from the one or more cameras.

Example 34 includes the device of Example 31, where video content is generated by the one or more processors at least partially based on the multiple image frames from the one or more cameras.

Example 35 includes the device of any of Examples 1-34, further comprising a display device coupled to the one or more processors and configured to output video content generated based on the multiple image frames.

Example 36 includes the device of any of Examples 1-35, further comprising a modem coupled to the one or more processors, the modem configured to transmit video content generated based on the multiple image frames to a second device for output by the second device.

Example 37 includes the device of any of Examples 1-36, further comprising a microphone configured to provide an input signal to the one or more processors to cause the one or more processors to generate video content based on the multiple image frames.

Example 38 includes the device of Example 37, where the one or more processors are configured to perform a voice-to-text operation on the input signal to generate text data; and identify a video content generation request based on the text data.

Example 39 includes the device of any of Examples 1-38, further comprising a speaker configured to output audio associated with video content generated based on the multiple image frames.

Example 40 includes the device of any of Examples 1-39, where the one or more processors are integrated in a mobile phone, a tablet computer device, a wearable electronic device, a virtual reality headset, a mixed reality headset, an augmented reality headset, or a camera device.

According to Example 41, a method of operating a processor of a video generation device, the method includes obtaining multiple image frames; generating multiple latent representation frames based on the multiple image frames, the multiple latent representation frames include latents; obtaining multiple output latent representations generated based on multiple diffusion sampling operations performed on the multiple latent representation frames, the multiple diffusion sampling operations performed based on a diffusion model; for a pair of latent representation frames of the multiple latent representation frames, determining flow values based on the multiple diffusion sampling operations performed the pair of latent representation frames; and performing, based on the flow values, a video generation operation.

Example 42 includes the method of Example 41, where the multiple image frames include a sequence of image frames of video content.

Example 43 includes the method of Example 41 or Example 42, where the flow values are associated with a flow map that represents a flow of the pair of latent representation frames.

Example 44 includes the method of any of Examples 41-43, where the one or more processors include an autoencoder.

Example 45 includes the method of Example 44, the method further includes generating the multiple latent representation frames based on the autoencoder.

Example 46 includes the method of Example 41-45, the method further includes decoding the multiple output latent representations to generate multiple output image frames.

Example 47 includes the method of any of Examples 41-46, where the diffusion model includes a latent diffusion model (LDM).

Example 48 includes the method of any of Examples 41-47, where the diffusion model has a U-Net architecture including a plurality of blocks.

Example 49 includes the method of any of Examples 41-48, where the diffusion model includes one or more transformers.

Example 50 includes the method of any of Examples 41-49, where the video generation operation includes a warping operation.

Example 51 includes the method of any of Examples 41-50, the method further includes, for at least one diffusion sampling operation of the multiple diffusion sampling operations, obtaining activations.

Example 52 includes the method of Example 51, the method further includes, for the pair of latent representation frames of the multiple latent representation frames, determining the flow values based on first activations obtained for a first latent representation frame of the pair of latent representation frames and second activations obtained for a second latent representation frame of the pair of latent representation frames.

Example 53 includes the method of any of Examples 41-52, where the flow values are based on a first set of diffusion sampling operations of the multiple diffusion sampling operations performed on the multiple latent representation frames.

Example 54 includes the method of Example 53, where the video generation operation is performed in association with a second set of diffusion sampling operations of the multiple diffusion sampling operations.

Example 55 includes the method of any of Examples 41-54, where each latent representation frame of the pair of latent representation frames is associated with a plurality of tokens.

Example 56 includes the method of Example 52, the method further includes, for the pair of latent representation frames, determining a set of distance values based on the activations obtained from the at least one diffusion sampling operation.

Example 57 includes the method of Example 56, where the set of distance values associated with a first plurality of tokens associated the first latent representation frame and a second plurality of tokens associated with the second latent representation frame.

Example 58 includes the method of Example 57, where, to determine the set of distance values, the method further includes determining a cosine distance based on the activations obtained for the first latent representation frame and the activations obtained for the second latent representation frame.

Example 59 includes the method of Example 58, where the set of distance values are arranged in a first dimension according to index values of the first plurality of tokens and in a second dimension according to index values of the second plurality of tokens.

Example 60 includes the method of Example 58, the method further includes, for the pair of latent representation frames of the multiple latent representation frames, identifying a first index value of a token of a first plurality of tokens of the first latent representation frame.

Example 61 includes the method of Example 60, the method further includes, for the pair of latent representation frames of the multiple latent representation frames, identifying, based on the set of distance values, a shortest distance value for the first index value of the token of the first plurality of tokens.

Example 62 includes the method of Example 61, the method further includes, for the pair of latent representation frames of the multiple latent representation frames, based on the identified shortest distance value, identifying a second index value of a token of the second plurality of tokens.

Example 63 includes the method of Example 62, the method further includes, for the pair of latent representation frames of the multiple latent representation frames, determining an offset value based on the first index value of the token of the first plurality of tokens and the second index value of the token of the second plurality of tokens.

Example 64 includes the method of Example 63, the method further includes, for the pair of latent representation frames of the multiple latent representation frames, determining, based on the offset value, a flow value for the token of the first plurality of tokens.

Example 65 includes the method of Example 52, the method further includes obtaining the activations from a transformer of one or more transformers of the diffusion model.

Example 66 includes the method of Example 65, where the first latent representation frame is associated with a first plurality of tokens, and the second latent representation frame is associated with a second plurality of tokens.

Example 67 includes the method of Example 66, the method further includes, for the pair of latent representation frames, and for each sampling operation of at least two sampling operations of the multiple diffusion sampling operations, determining a set of distance values based on the activations obtained from the sampling operation, the set of distance values associated with the first plurality of tokens and the second plurality of tokens.

Example 68 includes the method of Example 67, the method further includes, for the pair of latent representation frames, generating a set of distance values for the pair of latent representations based on an average of the multiple sets of distance values.

Example 69 includes the method of any of Examples 41-68, the method further includes receiving an input that includes a request to perform a text-based video generation, a text-based video content editing operation, a video enhancement operation, video compression, a data augmentation operation, or a combination thereof.

Example 70 includes the method of Example 69, where activations are obtained based on the input is received.

Example 71 includes the method of any of Examples 41-70, the method further includes generating, by one or more cameras, the multiple image frames.

Example 72 includes the method of Example 71, the method further includes receiving an input via an input device.

Example 73 includes the method of Example 72, where the input includes a request to generate output video content based on the diffusion model and the multiple image frames from the one or more cameras.

Example 74 includes the method of Example 71, where video content is generated at least partially based on the multiple image frames from the one or more cameras.

Example 75 includes the method of any of Examples 41-74, the method further includes outputting, by a display device, video content generated based on the multiple image frames.

Example 76 includes the method of any of Examples 41-75, the method further includes transmitting, via a modem, video content generated based on the multiple image frames to a second device for output by the second device.

Example 77 includes the method of any of Examples m 41-76, the method further includes providing, by a microphone, an input signal to generate video content based on the multiple image frames.

Example 78 includes the method of Example 77, the method further includes performing a voice-to-text operation on the input signal to generate text data; and identify a video content generation request based on the text data.

Example 79 includes the method of any of Examples 41-78, the method further includes outputting, by a speaker, output audio associated with video content generated based on the multiple image frames.

Example 80 includes the method of any of Examples 41-79, where the method is performed at a mobile phone, a tablet computer device, a wearable electronic device, a virtual reality headset, a mixed reality headset, an augmented reality headset, or a camera device.

According to Example 81, a non-transitory computer-readable medium storing instructions that are executable by one or more processors to cause the one or more processors to obtain multiple image frames; generate multiple latent representation frames based on the multiple image frames, the multiple latent representation frames include latents; obtain multiple output latent representations generated based on multiple diffusion sampling operations performed on the multiple latent representation frames, the multiple diffusion sampling operations performed based on a diffusion model; for a pair of latent representation frames of the multiple latent representation frames, determine flow values based on the multiple diffusion sampling operations performed the pair of latent representation frames; and perform, based on the flow values, a video generation operation.

Example 82 includes the non-transitory computer-readable medium of Example 81, where the multiple image frames include a sequence of image frames of video content.

Example 83 includes the non-transitory computer-readable medium of Example 81 or Example 82, where the flow values are associated with a flow map that represents a flow of the pair of latent representation frames.

Example 84 includes the non-transitory computer-readable medium of any of Examples 81-83 where the one or more processors include an autoencoder.

Example 85 includes the non-transitory computer-readable medium of Example 84, where the instructions are also executable by the one or more processors to cause the one or more processors to generate the multiple latent representation frames based on the autoencoder.

Example 86 includes the non-transitory computer-readable medium of any of Examples 81-85, where the instructions are also executable by the one or more processors to cause the one or more processors to decode the multiple output latent representations to generate multiple output image frames.

Example 87 includes the non-transitory computer-readable medium of any of Examples 81-86, where the diffusion model includes a latent diffusion model (LDM).

Example 88 includes the non-transitory computer-readable medium of any of Examples 81-87, where the diffusion model has a U-Net architecture including a plurality of blocks.

Example 89 includes the non-transitory computer-readable medium of any of Examples 81-88, where the diffusion model includes one or more transformers.

Example 90 includes the non-transitory computer-readable medium of any of Examples 81-89, where the video generation operation includes a warping operation.

Example 91 includes the non-transitory computer-readable medium of any of Examples 81-90, where the instructions are also executable by the one or more processors to cause the one or more processors to, for at least one diffusion sampling operation of the multiple diffusion sampling operations, obtain activations.

Example 92 includes the non-transitory computer-readable medium of Example 91, where the instructions are also executable by the one or more processors to cause the one or more processors to, for the pair of latent representation frames of the multiple latent representation frames, determine the flow values based on first activations obtained for a first latent representation frame of the pair of latent representation frames and second activations obtained for a second latent representation frame of the pair of latent representation frames.

Example 93 includes the non-transitory computer-readable medium of any of Examples 81-92, where the flow values are based on a first set of diffusion sampling operations of the multiple diffusion sampling operations performed on the multiple latent representation frames.

Example 94 includes the non-transitory computer-readable medium of Example 93, where the video generation operation is performed in association with a second set of diffusion sampling operations of the multiple diffusion sampling operations.

Example 95 includes the non-transitory computer-readable medium of Example 92, where each latent representation frame of the pair of latent representation frames is associated with a plurality of tokens.

Example 96 includes the non-transitory computer-readable medium of Example 95, where the instructions are also executable by the one or more processors to cause the one or more processors to, for the pair of latent representation frames, determine a set of distance values based on the activations obtained from the at least one diffusion sampling operation.

Example 97 includes the non-transitory computer-readable medium of Example 96, where the set of distance values associated with a first plurality of tokens associated the first latent representation frame and a second plurality of tokens associated with the second latent representation frame.

Example 98 includes the non-transitory computer-readable medium of Example 97, where, to determine the set of distance values, the instructions are also executable by the one or more processors to cause the one or more processors to determine a cosine distance based on the activations obtained for the first latent representation frame and the activations obtained for the second latent representation frame.

Example 99 includes the non-transitory computer-readable medium of Example 98, where the set of distance values are arranged in a first dimension according to index values of the first plurality of tokens and in a second dimension according to index values of the second plurality of tokens.

Example 100 includes the non-transitory computer-readable medium of Example 98, where the instructions are also executable by the one or more processors to cause the one or more processors to, for the pair of latent representation frames of the multiple latent representation frames, identify a first index value of a token of a first plurality of tokens of the first latent representation frame.

Example 101 includes the non-transitory computer-readable medium of Example 100, where the instructions are also executable by the one or more processors to cause the one or more processors to, for the pair of latent representation frames of the multiple latent representation frames, identify, based on the set of distance values, a shortest distance value for the first index value of the token of the first plurality of tokens.

Example 102 includes the non-transitory computer-readable medium of Example 101, where the instructions are also executable by the one or more processors to cause the one or more processors to, for the pair of latent representation frames of the multiple latent representation frames, based on the identified shortest distance value, identify a second index value of a token of the second plurality of tokens.

Example 103 includes the non-transitory computer-readable medium of Example 102, where the instructions are also executable by the one or more processors to cause the one or more processors to, for the pair of latent representation frames of the multiple latent representation frames, determine an offset value based on the first index value of the token of the first plurality of tokens and the second index value of the token of the second plurality of tokens.

Example 104 includes the non-transitory computer-readable medium of Example 103, where the instructions are also executable by the one or more processors to cause the one or more processors to, for the pair of latent representation frames of the multiple latent representation frames, determine, based on the offset value, a flow value for the token of the first plurality of tokens.

Example 105 includes the non-transitory computer-readable medium of Example 95, where the instructions are also executable by the one or more processors to cause the one or more processors to obtain the activations from a transformer of one or more transformers of the diffusion model.

Example 106 includes the non-transitory computer-readable medium of Example 105, where the first latent representation frame is associated with a first plurality of tokens, and the second latent representation frame is associated with a second plurality of tokens.

Example 107 includes the non-transitory computer-readable medium of Example 106, where the instructions are also executable by the one or more processors to cause the one or more processors to, for the pair of latent representation frames, and for each sampling operation of at least two sampling operations of the multiple diffusion sampling operations, determine a set of distance values based on the activations obtained from the sampling operation, the set of distance values associated with the first plurality of tokens and the second plurality of tokens.

Example 108 includes the non-transitory computer-readable medium of Example 107, where the instructions are also executable by the one or more processors to cause the one or more processors to, for the pair of latent representation frames, generate a set of distance values for the pair of latent representations based on an average of the multiple sets of distance values.

Example 109 includes the non-transitory computer-readable medium of any of Examples 81-108, where the instructions are also executable by the one or more processors to cause the one or more processors to receive an input that includes a request to perform a text-based video generation, a text-based video content editing operation, a video enhancement operation, video compression, a data augmentation operation, or a combination thereof.

Example 110 includes the non-transitory computer-readable medium of Example 91, where the activations are obtained after an input is received.

Example 111 includes the non-transitory computer-readable medium of any of Examples 81-110, where the instructions are also executable by the one or more processors to cause the one or more processors to generate the multiple image frames.

Example 112 includes the non-transitory computer-readable medium of Example 111, where the instructions are also executable by the one or more processors to cause the one or more processors to an input.

Example 113 includes the non-transitory computer-readable medium of Example 112, where the input includes a request to generate output video content based on the diffusion model and based on the multiple image frames from one or more cameras.

Example 114 includes the non-transitory computer-readable medium of Example 111, where video content is generated at least partially based on the multiple image frames from one or more cameras.

Example 115 includes the non-transitory computer-readable medium of any of Examples 81-114, where the instructions are also executable by the one or more processors to cause the one or more processors to output video content generated based on the multiple image frames.

Example 116 includes the non-transitory computer-readable medium of any of Examples 81-115 where the instructions are also executable by the one or more processors to cause the one or more processors to transmit, via a modem, video content generated based on the multiple image frames to a second device for output by the second device.

Example 117 includes the non-transitory computer-readable medium of any of Examples 81-116, where the instructions are also executable by the one or more processors to cause the one or more processors to receive, via a microphone, an input signal to generate video content based on the multiple image frames.

Example 118 includes the non-transitory computer-readable medium of Example 117, where the instructions are also executable by the one or more processors to cause the one or more processors to perform a voice-to-text operation on the input signal to generate text data; and identify a video content generation request based on the text data.

Example 119 includes the non-transitory computer-readable medium of any of Examples 81-118, where the instructions are also executable by the one or more processors to cause the one or more processors to output audio associated with video content generated based on the multiple image frames.

Example 120 includes the non-transitory computer-readable medium of any of Examples 81-119, where the one or more processors are integrated in a mobile phone, a tablet computer device, a wearable electronic device, a virtual reality headset, a mixed reality headset, an augmented reality headset, or a camera device.

According to Example 121, an apparatus includes means for obtaining multiple image frames; means for generating multiple latent representation frames based on the multiple image frames, the multiple latent representation frames include latents; means for obtaining multiple output latent representations generated based on multiple diffusion sampling operations performed on the multiple latent representation frames, the multiple diffusion sampling operations performed based on a diffusion model; means for determining, for a pair of latent representation frames of the multiple latent representation frames, flow values based on the multiple diffusion sampling operations performed the pair of latent representation frames; and means for performing a video generation operation based on the flow values.

Example 122 includes the apparatus of Example 121, where the multiple image frames include a sequence of image frames of video content.

Example 123 includes the apparatus of Example 121 or Example 122, where the flow values are associated with a flow map that represents a flow of the pair of latent representation frames.

Example 124 includes the apparatus of any of Examples 121-123, where the means for generating the multiple latent representation frames includes an autoencoder.

Example 125 includes the apparatus of Example 124, the apparatus includes means for generating the multiple latent representation frames based on the autoencoder.

Example 126 includes the apparatus of any of Examples 121-125, the apparatus includes means for decoding the multiple output latent representations to generate multiple output image frames.

Example 127 includes the apparatus of any of Examples 121-126, where the diffusion model includes a latent diffusion model (LDM).

Example 128 includes the apparatus of any of Examples 121-127, where the diffusion model has a U-Net architecture including a plurality of blocks.

Example 129 includes the apparatus of any of Examples 121-128, where the diffusion model includes one or more transformers.

Example 130 includes the apparatus of any of Examples 121-129, where the video generation operation includes a warping operation.

Example 131 includes the apparatus of any of Examples 121-130, the apparatus includes means for obtaining activations for at least one diffusion sampling operation of the multiple diffusion sampling operations.

Example 132 includes the apparatus of Example 131, the apparatus includes means for determining, for the pair of latent representation frames of the multiple latent representation frames, the flow values based on first activations obtained for a first latent representation frame of the pair of latent representation frames and second activations obtained for a second latent representation frame of the pair of latent representation frames.

Example 133 includes the apparatus of any of Examples 121-132, where the flow values are based on a first set of diffusion sampling operations of the multiple diffusion sampling operations performed on the multiple latent representation frames.

Example 134 includes the apparatus of Example 133, where the video generation operation is performed in association with a second set of diffusion sampling operations of the multiple diffusion sampling operations.

Example 135 includes the apparatus of Example 132, where each latent representation frame of the pair of latent representation frames is associated with a plurality of tokens.

Example 136 includes the apparatus of Example 135, the apparatus includes means for determining, for the pair of latent representation frames, a set of distance values based on the activations obtained from the at least one diffusion sampling operation.

Example 137 includes the apparatus of Example 136, where the set of distance values associated with a first plurality of tokens associated the first latent representation frame and a second plurality of tokens associated with the second latent representation frame.

Example 138 includes the apparatus of Example 137, where the means for determining the set of distance values includes means for determining a cosine distance based on the activations obtained for the first latent representation frame and the activations obtained for the second latent representation frame.

Example 139 includes the apparatus of Example 138, where the set of distance values are arranged in a first dimension according to index values of the first plurality of tokens and in a second dimension according to index values of the second plurality of tokens.

Example 140 includes the apparatus of Example 138, the apparatus includes means for identifying, for the pair of latent representation frames of the multiple latent representation frames, a first index value of a token of a first plurality of tokens of the first latent representation frame.

Example 141 includes the apparatus of Example 140, the apparatus includes means for identifying, for the pair of latent representation frames of the multiple latent representation frames, and based on the set of distance values, a shortest distance value for the first index value of the token of the first plurality of tokens.

Example 142 includes the apparatus of Example 141, the apparatus includes means for identifying, for the pair of latent representation frames of the multiple latent representation frames, based on the identified shortest distance value, a second index value of a token of the second plurality of tokens.

Example 143 includes the apparatus of Example 142, the apparatus includes means for determining, for the pair of latent representation frames of the multiple latent representation frames, an offset value based on the first index value of the token of the first plurality of tokens and the second index value of the token of the second plurality of tokens.

Example 144 includes the apparatus of Example 143, the apparatus includes means for determining, for the pair of latent representation frames of the multiple latent representation frames, and based on the offset value, a flow value for the token of the first plurality of tokens.

Example 145 includes the apparatus of Example 135, the apparatus includes means for obtaining the activations from a transformer of one or more transformers of the diffusion model.

Example 146 includes the apparatus of Example 145, where the first latent representation frame is associated with a first plurality of tokens, and the second latent representation frame is associated with a second plurality of tokens.

Example 147 includes the apparatus of Example 146, the apparatus includes means for determining, for the pair of latent representation frames, and for each sampling operation of at least two sampling operations of the multiple diffusion sampling operations, a set of distance values based on the activations obtained from the sampling operation, the set of distance values associated with the first plurality of tokens and the second plurality of tokens.

Example 148 includes the apparatus of Example 147, the apparatus includes means for generating, for the pair of latent representation frames, a set of distance values for the pair of latent representations based on an average of the multiple sets of distance values.

Example 149 includes the apparatus of any of Examples 121-148, the apparatus includes means for receiving an input that includes a request to perform a text-based video generation, a text-based video content editing operation, a video enhancement operation, video compression, a data augmentation operation, or a combination thereof.

Example 150 includes the apparatus of Example 131, where the activations are obtained after an input is received.

Example 151 includes the apparatus of any of Examples 121-150, the apparatus includes means for generating, by one or more cameras, the multiple image frames.

Example 152 includes the apparatus of Example 151, the apparatus includes means for receiving an input via an input device.

Example 153 includes the apparatus of Example 152, where the input includes a request to generate output video content based on the diffusion model and the multiple image frames from one or more cameras.

Example 154 includes the apparatus of Example 151, where video content is generated at least partially based on the multiple image frames from the one or more cameras.

Example 155 includes the apparatus of any of Examples 121-154, the apparatus includes means for outputting, by a display device, video content generated based on the multiple image frames.

Example 156 includes the apparatus of any of Examples 121-155, the apparatus includes means for transmitting, via a modem, video content generated based on the multiple image frames to a second device for output by the second device.

Example 157 includes the apparatus of any of Examples 121-156, the apparatus includes means for providing, by a microphone, an input signal to generate video content based on the multiple image frames.

Example 158 includes the apparatus of Example 157, the apparatus includes means for performing a voice-to-text operation on the input signal to generate text data; and means for identifying a video content generation request based on the text data.

Example 159 includes the apparatus of any of Examples 121-158, the apparatus includes means for outputting, by a speaker, output audio associated with video content generated based on the multiple image frames.

Example 160 includes the apparatus of any of Examples 121-159, where the apparatus includes a mobile phone, a tablet computer device, a wearable electronic device, a virtual reality headset, a mixed reality headset, an augmented reality headset, or a camera device.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store data corresponding to a diffusion model; and
one or more processors coupled to the memory and configured to:
obtain multiple image frames;
generate multiple latent representation frames based on the multiple image frames, the multiple latent representation frames include latents;
obtain multiple output latent representations generated based on multiple diffusion sampling operations performed on the multiple latent representation frames, the multiple diffusion sampling operations performed based on the diffusion model;
for a pair of latent representation frames of the multiple latent representation frames, determine flow values based on the multiple diffusion sampling operations performed the pair of latent representation frames; and
perform, based on the flow values, a video generation operation.

2. The device of claim 1, wherein:
the multiple image frames include a sequence of image frames of video content;
the flow values are associated with a flow map that represents a flow of the pair of latent representation frames;
the one or more processors include an autoencoder; and
wherein the one or more processors are configured to:
generate the multiple latent representation frames based on the autoencoder; and
decode the multiple output latent representations to generate multiple output image frames.

3. The device of claim 1, wherein the one or more processors are configured to:
for at least one diffusion sampling operation of the multiple diffusion sampling operations, obtain activations; and
for the pair of latent representation frames of the multiple latent representation frames, determine the flow values based on first activations obtained for a first latent representation frame of the pair of latent representation frames and second activations obtained for a second latent representation frame of the pair of latent representation frames.

4. The device of claim 1, wherein:
the diffusion model includes a latent diffusion model (LDM);
the diffusion model has a U-Net architecture including a plurality of blocks;
the diffusion model includes one or more transformers;
the video generation operation includes a warping operation; or
a combination thereof.

5. The device of claim 3, wherein:
the flow values are based on a first set of diffusion sampling operations of the multiple diffusion sampling operations performed on the multiple latent representation frames; and
the video generation operation is performed in association with a second set of diffusion sampling operations of the multiple diffusion sampling operations.

6. The device of claim 3, wherein:
each latent representation frame of the pair of latent representation frames is associated with a plurality of tokens; and
the one or more processors are configured to, for the pair of latent representation frames:
determine a set of distance values based on the activations obtained from the at least one diffusion sampling operation, the set of distance values associated with a first plurality of tokens associated the first latent representation frame and a second plurality of tokens associated with the second latent representation frame.

7. The device of claim 6, wherein, to determine the set of distance values, the one or more processors are configured to:
determine a cosine distance based on the activations obtained for the first latent representation frame and the activations obtained for the second latent representation frame; and
wherein the set of distance values are arranged in a first dimension according to index values of the first plurality of tokens and in a second dimension according to index values of the second plurality of tokens.

8. The device of claim 6, wherein the one or more processors are configured to, for the pair of latent representation frames of the multiple latent representation frames:
identify a first index value of a token of a first plurality of tokens of the first latent representation frame;
identify, based on the set of distance values, a shortest distance value for the first index value of the token of the first plurality of tokens;
based on the identified shortest distance value, identify a second index value of a token of the second plurality of tokens;
determine an offset value based on the first index value of the token of the first plurality of tokens and the second index value of the token of the second plurality of tokens; and
determine, based on the offset value, a flow value for the token of the first plurality of tokens.

9. The device of claim 5, wherein:
each latent representation frame of the pair of latent representation frames is associated with a plurality of tokens; and
the one or more processors are configured to obtain the activations from a transformer of one or more transformers of the diffusion model.

10. The device of claim 9, wherein:
the first latent representation frame is associated with a first plurality of tokens, and the second latent representation frame is associated with a second plurality of tokens; and
the one or more processors are configured to, for the pair of latent representation frames:
for each sampling operation of at least two sampling operations of the multiple diffusion sampling operations, determine a set of distance values based on the activations obtained from the sampling operation, the set of distance values associated with the first plurality of tokens and the second plurality of tokens; and
generate a set of distance values for the pair of latent representations based on an average of the multiple sets of distance values.

11. The device of claim 1, wherein the one or more processors are configured to:
receive an input that includes a request to perform a text-based video generation, a text-based video content editing operation, a video enhancement operation, video compression, a data augmentation operation, or a combination thereof; and
one or more activations are obtained based on the input.

12. The device of claim 1, further comprising:
one or more cameras coupled to the one or more processors and configured to generate the multiple image frames; and
an input device configured to receive an input and provide the input to the one or more processors, wherein the input includes a request to generate output video content based on the diffusion model and the multiple image frames from the one or more cameras.

13. The device of claim 1, further comprising one or more cameras coupled to the one or more processors and configured to generate multiple image frames, wherein video content is generated by the one or more processors at least partially based on the multiple image frames from the one or more cameras.

14. The device of claim 1, further comprising a display device coupled to the one or more processors and configured to output video content generated based on the multiple image frames.

15. The device of claim 1, further comprising a modem coupled to the one or more processors, the modem configured to transmit video content generated based on the multiple image frames to a second device for output by the second device.

16. The device of claim 1, further comprising:
a microphone configured to provide an input signal to the one or more processors to cause the one or more processors to generate video content based on the multiple image frames; and
wherein the one or more processors are configured to:
perform a voice-to-text operation on the input signal to generate text data; and
identify a video content generation request based on the text data.

17. The device of claim 1, further comprising a speaker configured to output audio associated with video content generated based on the multiple image frames.

18. The device of claim 1, wherein the one or more processors are integrated in a mobile phone, a tablet computer device, a wearable electronic device, a virtual reality headset, a mixed reality headset, an augmented reality headset, or a camera device.

19. A method of operating a processor of a video generation device, the method comprising:
obtaining multiple image frames;
generating multiple latent representation frames based on the multiple image frames, the multiple latent representation frames include latents;
obtaining multiple output latent representations generated based on multiple diffusion sampling operations performed on the multiple latent representation frames, the multiple diffusion sampling operations performed based on a diffusion model;
for a pair of latent representation frames of the multiple latent representation frames, determining flow values based on the multiple diffusion sampling operations performed the pair of latent representation frames; and
performing, based on the flow values, a video generation operation.

20. A non-transitory computer-readable medium storing instructions that are executable by one or more processors to cause the one or more processors to:
obtain multiple image frames;
generate multiple latent representation frames based on the multiple image frames, the multiple latent representation frames include latents;
obtain multiple output latent representations generated based on multiple diffusion sampling operations performed on the multiple latent representation frames, the multiple diffusion sampling operations performed based on a diffusion model;
for a pair of latent representation frames of the multiple latent representation frames, determine flow values based on the multiple diffusion sampling operations performed the pair of latent representation frames; and
perform, based on the flow values, a video generation operation.
